(19) United States
(12) Patent Application Publication
(10) Pub. No.: US 2008/0007808 A1
(43) Pub. Date: Jan. 10, 2008

(54) Hologram Recording and Reproducing Method, Device and System

(75) Inventors: Masakazu Ogasawara, Saitama (JP); Yoshihisa Itoh, Saitama (JP); Akihiro Tachibana, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Tokyo (JP)

(21) Appl. No.: 11/792,960

(22) PCT Filed: Nov. 22, 2005
(86) PCT No.: PCT/JP05/21927

§ 371 Date: Sep. 7, 2007

(30) Foreign Application Priority Data
Dec. 17, 2004 (JP) 2004-365204
Jun. 17, 2005 (JP) 2005-177545

(51) Int. Cl. G03H 1/02

(52) U.S. Cl. 359/30

(57) ABSTRACT

A hologram device includes: a support section that keeps hold of, to be able to be attachable and removable, a hologram record carrier including a hologram recording layer stored therein with an optical interference pattern of a coherent signal light and a coherent reference light as a diffraction grating; a light source that generates the coherent reference light; a signal light generation section that is disposed on an optical axis, and generates the signal light by modulating the reference light in accordance with recording information; and an interference section that is disposed on the optical axis, and forms the diffraction grating being the optical interference pattern inside of the hologram recording layer by directing the signal light and the reference light toward the hologram recording layer. The signal light generation section is provided with a spatial light modulator, and the spatial light modulator is configured by a center are a disposed on the optical axis for passing through or reflecting the reference light with no modulation, and a spatial light modulation are a disposed around the center are a for generating the signal light by modulating the reference light in accordance with the recording information. The reference light is propagated on the optical axis, and the signal light is propagated around the reference light with spatial separation therefrom. The interference section includes an objective lens and an optical device, and the objective lens and the optical device gather the reference light at a first focal point, and the signal light at a second focal point being different from the first focal point.

### TECHNICAL FIELD

The present invention relates to a record carrier such as an optical disk, optical card and the like with which information recording or information reproduction is optically performed and, more specifically, to a hologram recording and reproducing method, device, and system including a hologram recording layer being information-recordable and information-reproducible by irradiation of luminous fluxes.

### BACKGROUND ART

For high-density information recording, a hologram capable of high-density recording of two-dimensional data has been receiving attention. This hologram is characterized in that the wavefront of a light carrying recording information is recorded as a change, in volume, of refractive index to a recording medium made of a light-sensitive material such as photorefractive materials and the like. With multiplex recording onto a hologram record carrier, the recording capacity can be dramatically increased. As the configuration, known is a recording medium including a substrate, an information recording layer, and a reflective layer formed in this order.

There is a previous technology (refer to JP-T-2002-513981) for performing polarization hologram recording, in an information recording apparatus of exposing, coaxially, a thin-film recording layer to an object light and a reference light to cause interference for recording of a hologram, by gathering circular polarized object light and reference light with each different rotation direction onto a recording medium using the same lens. With such polarization holographic recording, using a quarter-wave plate, an object light and a reference light of two plane waves each having a polarized light orthogonal to each other are regarded as a right-handed circular polarized light and a left-handed circular polarized light, respectively, and with the interference caused in the recording medium, one “polarization hologram” is recorded. At the time of reproduction, used are another optical system and a reference light with a different wavelength from that at the time of recording. In the optical system for reproduction, with any special half-wave plate having an aperture at the center, the result derived thereby is a reproduced light being a reference light in an inner are a and being polarized the same as the inner reference light. Because the reproduced light has an angle of divergence, it passes through the portion around the aperture of the half-wave plate. It is thus changed in polarization direction, and is separated by a polarization beam splitter so that a pass-through reproduced light is detected. The technology of JP-T-2002-513981 is thus required to change the wavelength and the optical system at the time of recording and reproduction, and no reflected light is returned from a recording medium at the time of recording. Therefore, another optical system is required for exercising servo control for positioning of an irradiation light and a recording medium. Moreover, when the reference light is a collimated light in the recording medium, no shift multiplex recording is possible.

As another previous technology for polarization hologram, there is a recording method of separating an object light and a reference light to have each different polarization direction, and merging their optical paths again so as to make the object light occupy the outer rim portion of a luminous flux and the reference light occupy the center portion of the luminous flux. Also, with the method, the object light and the reference light are gathered, coaxially, on a recording layer as circular polarized light varying in rotation direction, and interference is caused between the two luminous fluxes on a thin-film polarization hologram recording layer (refer to WO 02/05270 A1).

Previously, information light is converged and irradiated so as to have the smallest diameter on the border surface between a hologram recording layer and a protective layer in a recording medium, and is reflected on a reflection layer. At the same time, a reference light for recording use is so converged as to have the smallest diameter before the border surface between the hologram recording layer and the protection layer, and is irradiated as a diverging light to cause interference. In such a manner, recording has been performed to the hologram recording layer (refer to JP-A-11-311938).

There is also another previous technology in which, in a recording optical system, information light is converged on a reflective layer, and a reference light for recording use is irradiated in such a manner that the reference light for recording use is defocused on the reflective layer, and a conjugate focal point of the reference light for recording use comes closer to the side of a substrate than the border surface between the substrate and an information recording layer (refer to JP-A-2004-171611).

FIGS. 1 and 2 each show an exemplary configuration of an objective lens in the previous technologies, e.g., recording and reproduction are performed from one side of a recording layer in JP-A-11-311938 and JP-A-2004-171611.

In either technologies, at the time of recording, as shown in the drawings, a reference light and a signal light are directed to an objective lens OB so as to overlap, coaxially, each other. After passing through the objective lens OB, the reference light and the signal light are so set as to have each different focus distance.

In FIG. 1(a), a signal light is gathered at a position where a reflective layer is supposed to be disposed (focal point P), and a reference light is gathered in front of the focal point P (focal point P1). In FIG. 2(a), a signal light is gathered at a position where a reflective layer is supposed to be disposed (focal point P), and a reference light is gathered behind the focal point P (focal point P2). In either cases, between the reference light and the signal light gathered by the objective lens OB, interference is always caused on an optical axis. Therefore, as shown in FIGS. 1(b) and 2(b), when a reflective layer is disposed at the position of the focal point P of a signal light, and when a recording medium is disposed between an objective lens and the reflective layer, a reference light and a signal light pass through the recording medium with reciprocating motions so that hologram recording is performed. Also at the time of reproduction, a reference light passes through the recording medium with reciprocating motions, and the reflected reference light will be back to the objective lens OB together with a reproduced light.

As shown in FIG. 3, in any technology, a specific hologram for recording includes four types of hologram recording A (reflecting reference light and reflecting signal light), hologram recording B (incoming reference light and reflecting signal light), hologram recording C (reflecting reference light and incoming signal light), and hologram recording D (incoming reference light and incoming signal light). A hologram for reproduction also includes four types of hologram recording A (read by reflecting reference light), hologram recording B (read by incoming reference light), hologram recording C (read by reflecting reference light), and hologram recording D (read by incoming reference light).

Accordingly, with such previous technologies, interference occurs to every beam in a recording layer (incoming light and reflecting light of reference light and incoming light and reflecting light of information light), and thus a plurality of holograms are subjected to recording and reproduction. This is as described in JP-A-2004-171611, paragraphs (0096) and (0097), for example. Also in the technology of WO 02/05270 A1 in which a reference light and a signal light directed to a recording medium are coaxially overlapped, similarly, a plurality of holograms are subjected to recording, and therefrom, reproduced lights are reproduced.

### DISCLOSURE OF THE INVENTION

With the previous technologies, when a hologram is recorded to a hologram record carrier having a reflective surface, interference occurs to four luminous fluxes of incoming reference light and signal light and reflecting reference light and signal light, and thus four holograms are subjected to recording, whereby the capability performance of the hologram recording layer has been needlessly used. Therefore, at the time of information reproduction, because the reference light is reflected on a reflective layer of the hologram record carrier, this requires separation from the reproduced light from any reproduced holograph. This thus causes degradation of the reading capability of a reproduction signal.

Moreover, because a large number of optical components have been used for generation and merging of a reference light and a signal light, there is a demand for the size reduction of apparatus.

In consideration thereof, an exemplary object of the present invention is to provide a hologram recording method, device, and system enabling stable recording and reproduction.

A hologram recording method of the present invention is a hologram recording method of recording information to a hologram record carrier including a hologram recording layer stored therein with an optical interference pattern of a reference light and a signal light as a diffraction grating, characterized by including:

a step of disposing a reflective layer on a side opposite to a light exposure surface of the hologram recording layer; and

a step of directing, with convergence by an objective lens, a coherent reference light and a signal light being a result of modulating the reference light in accordance with recording information to the reflective layer, coaxially about an optical axis, to allow passage through the hologram recording layer, and making the lights reflected on the reflective layer, wherein

in the step of making the lights reflected on the reflective layer, the diffraction grating is formed through interference between the reference light and the signal light in the hologram recording layer by propagating the reference light on the optical axis for gathering on the reflective layer, and by propagating the signal light around the reference light with spatial separation from the reference light for irradiation in such a manner as to derive a defocus state on the reflective layer.

A hologram reproducing method of the present invention is a hologram reproducing method of reproducing-information from a hologram record carrier recorded with the information by the hologram recording method of described above, characterized by including:

a step of disposing the reflective layer on a side opposite to the light exposure surface of the hologram recording layer;

a step of generating a reproduced light from the diffraction grating by gathering, with convergence of a reference light by the objective lens, the light on the reflective layer to allow passage through the diffraction grating of the hologram recording layer; and

a step of guiding the reproduced light to a photodetector by the objective lens.

A hologram recording device of the present invention is characterized by including:

a support section that keeps hold of, to be able to be attachable and removable, a hologram record carrier including a hologram recording layer stored therein with an optical interference pattern of a coherent signal light and a coherent reference light as a diffraction grating;

a light source that generates the coherent reference light;

a signal light generation section that is disposed on an optical axis, and generates the signal light by modulating the reference light in accordance with recording information; and

an interference section that is disposed on the optical axis, and forms the diffraction grating being the optical interference pattern inside of the hologram recording layer by directing the signal light and the reference light toward the hologram recording layer, wherein

the signal light generation section is provided with a spatial light modulator, and the spatial light modulator is disposed on the optical axis to generate, for propagation, the reference light on the optical axis and the signal light around the reference light with spatial separation therefrom, and

the interference section includes an objective lens disposed on the optical axis for gathering the signal light at a second focal point, and an optical device that is disposed coaxially to the objective lens, and has a function of gathering the reference light having been passed through the objective lens at a first focal point closer to the objective lens than the second focal point.

A hologram reproducing device of the present invention is characterized by including:

a support section that, when a reflective layer is disposed on a side opposite to a light exposure surface of a hologram recording layer, and with convergence by an objective lens, when a coherent referent light and a signal light being a result of modulating the reference light in accordance with recording information are directed to the reflective layer, coaxially about an optical axis, to allow passage through the hologram recording layer, propagates the reference light on the optical axis for gathering on the reflective layer, and propagates the signal light around the reference light with spatial separation from the reference light for irradiation in such a manner as to derive a defocus state on the reflective layer, and after light reflection on the reflective layer, causes interference between the reference light and the signal light in the hologram recording layer for keeping hold of, to be able to be attachable and removable, a hologram record carrier stored therein with an optical interference pattern as a diffraction grating;

a light source that generates the reference light; and

an interference section that generates a reproduced wave corresponding to the signal light by directing the reference light to the diffraction grating, wherein

the support section keeps hold of the hologram record carrier in such a manner that the reflective layer comes on the side opposite to the light exposure surface of the hologram recording layer, and

the interference section includes a photodetector disposed on the optical axis for detecting a reproduced light generated by the diffraction grating, and the objective lens for gathering the reference light on the optical axis in such a manner as to allow passage through the diffraction grating of the hologram recording layer, and receiving the reproduced wave for guiding to the photodetector.

An optical pickup device of the present invention is an optical pickup device that records or reproduces information to and from a hologram record carrier including a hologram recording layer stored therein with an optical interference pattern of a reference light and a signal light as a diffraction grating, characterized by including:

a light source that generates the coherent reference light;

a spatial light modulator configured by a center are a disposed on an optical axis for passing through or reflecting the reference light, and a spatial light modulation are a disposed around the center are a for generating the signal light through partial separation of the reference light, and that separates, for propagation, the reference light on the optical axis and the signal light around the reference light with spatial separation therefrom,

an objective lens that is disposed on the optical axis, and gathers the signal light at a second focal point;

an optical device that is disposed coaxially to the objective lens, and has a function of gathering the reference light having been passed through the objective lens at a first focal point closer to the objective lens than the second focal point; and

photodetection means for, when the reference light is directed to the hologram recording layer, receiving and detecting a light returned from the hologram recording layer via the objective lens.

A hologram recording system of the present invention is a hologram recording system that records information to a hologram record carrier including a hologram recording layer stored therein with an optical interference pattern of a reference light and a signal light as a diffraction grating, characterized by including:

generation means for generating a coherent reference light and a signal light being a result of modulating the reference light in accordance with recording information;

interference means provided with an objective lens optical system disposed on an optical axis for causing interference between the reference light and the signal light by propagating, coaxially, the reference light on the optical axis and the signal light circularly around the reference light with spatial separation therebetween, by gathering the reference light at a first focal point closer to the objective lens optical system, and by gathering the signal light at a second focal point being further than the first focal point;

a hologram record carrier including the hologram recording layer between the first focal point and the second focal point; and

reflection means being positioned at the first focal point.

A hologram reproducing system of the present invention is a hologram reproducing system that reproduces information from a hologram record carrier including a hologram recording layer stored therein with an optical interference pattern of a reference light and a signal light as a diffraction grating, characterized by including

in addition to the hologram recording system described above, detection means for, when generating a reproduced light from the diffraction grating by making the reference light pass through the diffraction grating of the hologram recording layer with convergence of the reference light at the first focal point by the objective lens optical system, guiding the reproduced light to a photodetector by the objective lens optical system.

### BRIEF DESCRIPTION OF THE DRAWINGS

FIGS. 1 to 3 are each a schematic partial cross sectional view of a hologram record carrier for use to illustrate previous hologram recording.

FIG. 4 is a front view of an objective lens viewed from an optical axis in an embodiment of the present invention.

FIG. 5 is a schematic partial cross sectional view of a hologram record carrier and the objective lens for use to illustrate hologram recording in the embodiment of the present invention.

FIG. 6 is a schematic partial cross sectional view of the hologram record carrier for use to illustrate the hologram recording in the embodiment of the present invention.

FIG. 7 is a schematic partial cross sectional view of the hologram record carrier and the objective lens for use to illustrate hologram reproduction in the embodiment of the present invention.

FIG. 8 is a schematic partial cross sectional view of a hologram record carrier and an objective lens module for use to illustrate hologram recording in another embodiment of the present invention.

FIG. 9 is a schematic partial cross sectional view of the hologram record carrier and an objective lens in another other embodiment of the present invention.

FIG. 10 is a diagram showing the overall configuration about pickup of a hologram device that records and reproduces information of the hologram record carrier in the embodiment of the present invention.

FIG. 11 is a front view of the hologram device in the embodiment of the present invention, viewed from an optical axis of a pickup spatial light modulator.

FIG. 12 is a front view of a hologram device in another embodiment of the present invention, viewed from an optical axis of a pickup spatial light modulator.

FIG. 13 is a perspective view of a pickup reference light separation prism of the hologram device in the embodiment of the present invention.

FIG. 14 is a diagram showing the overall configuration about pickup of the hologram device that records and reproduces information of the hologram record carrier in the embodiment of the present invention.

FIG. 15 is a front view of the hologram device in the embodiment of the present invention, showing a part of a pickup photodetector.

FIGS. 16 and 17 are each a diagram showing the overall configuration about pickup of the hologram device that records and reproduces information of the hologram record carrier in the embodiment of the present invention.

FIGS. 18 and 19 are each a diagram showing the overall configuration about pickup of the hologram device that records and reproduces information of the hologram record carrier in another embodiment of the present invention.

FIG. 20 is a front view of the hologram device in another embodiment of the present invention, viewed from an optical axis of a pickup polarization spatial light modulator.

FIG. 21 is a diagram showing the overall configuration about pickup of the hologram device in another embodiment of the present invention.

FIG. 22 is a front view of the hologram device in another embodiment of the present invention, viewed from an optical axis of a pickup optical device for servo detection use.

FIG. 23 is a front view of the hologram device in another embodiment of the present invention, viewed from an optical axis of a multiunit photodetector for pickup signal detection use.

FIG. 24 is a diagram showing the overall configuration about pickup of the hologram device in another embodiment of the present invention, showing a multiunit photodetector for signal detection use.

FIG. 25 is a diagram showing the overall configuration about pickup of the hologram device that records and reproduces information of the hologram record carrier in another embodiment of the present invention.

FIG. 26 is a front view of the hologram device in another embodiment of the present invention, viewed from an optical axis of a spatial light modulator being a piece with a pickup convex lens optical device.

FIG. 27 is a partial cross sectional view of the hologram device in another embodiment of the present invention, showing the spatial light modulator being a piece with the pickup convex lens optical device.

FIG. 28 is a partial cross sectional view of the hologram device in another embodiment of the present invention, showing a spatial light modulator being a piece with a pickup through-light diffractive optical device.

FIG. 29 is a diagram showing the overall configuration about pickup of the hologram device in another embodiment of the present invention, using a reflective polarization spatial light modulator being a piece with a concave mirror optical device.

FIG. 30 is a diagram showing the configuration of the hologram device in the embodiment of the present invention.

FIG. 31 is a perspective view of a hologram record carrier disk in the embodiment of the present invention.

FIG. 32 is a perspective view showing the perspective view of a hologram record carrier card in another embodiment of the present invention.

FIG. 33 is a plan view of the hologram record carrier disk in another embodiment of the present invention.

FIG. 34 is a schematic partial cross sectional view of the hologram record carrier and the objective lens for use to illustrate the hologram recording in another embodiment of the present invention.

FIG. 35 is a schematic partial cross sectional view of the hologram record carrier for use to illustrate the hologram recording in another embodiment of the present invention.

FIG. 36 is a schematic partial cross sectional view of the hologram record carrier and the objective lens for use to illustrate the hologram recording in another embodiment of the present invention.

FIG. 37 is schematic partial cross sectional view of the hologram record carrier and the objective lens module for use to illustrate the hologram recording in another embodiment of the present invention.

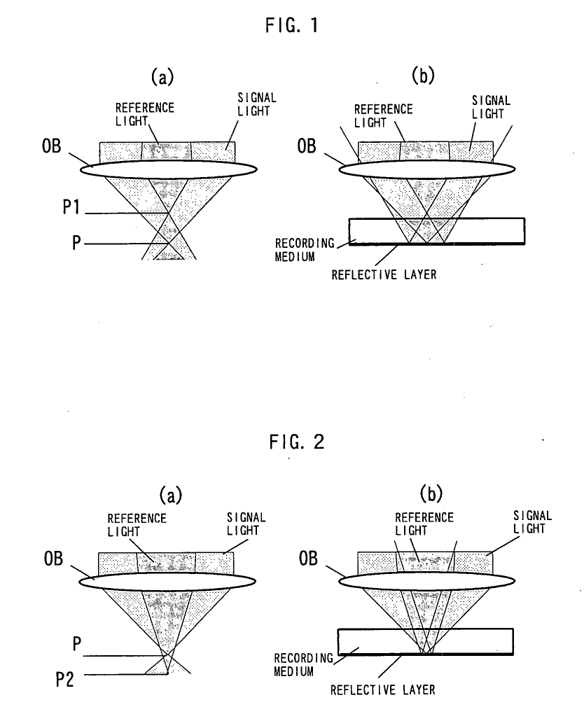

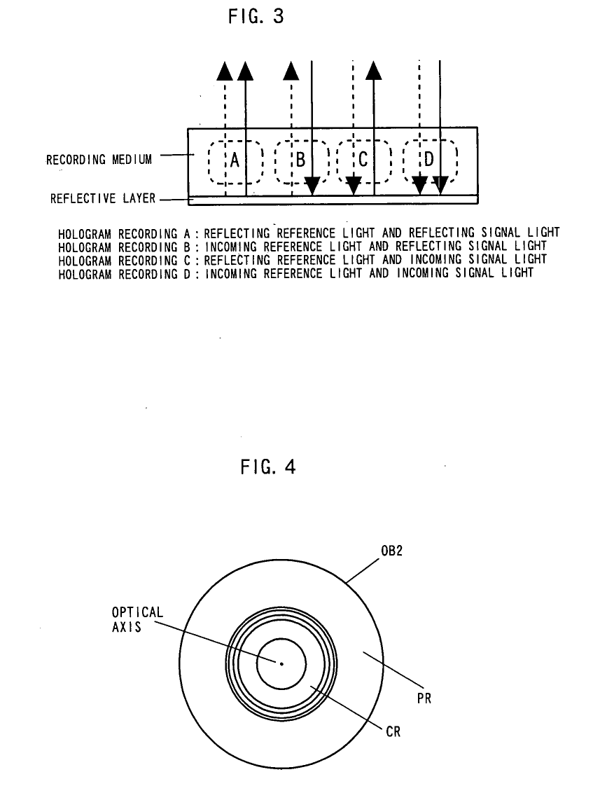

### DETAILED DESCRIPTION OF THE INVENTION

In the below, embodiments of the present invention are described by referring to the accompanying drawings.

<Principle of Recording and Reproduction>

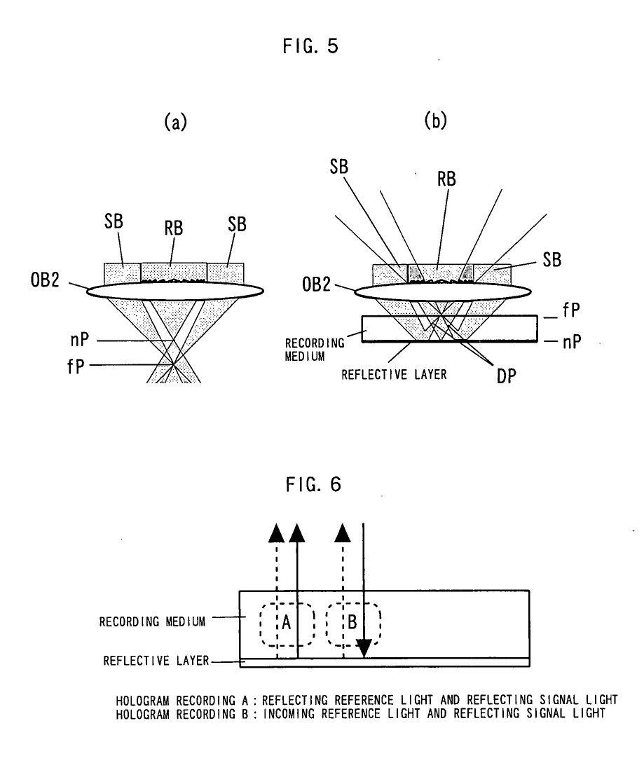

FIG. 4 shows an objective lens OB2 having two focal points on an optical axis, i.e., a so-called double focus lens, for use in an embodiment. FIG. 5 shows an exemplary configuration of an objective lens optical system disposed on the optical axis of the embodiment.

The double focus lens OB2 is a condenser configured by a center are a CR including the optical axis and a circular are a PR therearound, with which a light passed through the circular are a PR is gathered at a long-distance focal point fP (second focal point), and a light passed through the center are a CR is gathered at a short-range focal point nP (first focal point). In the double focus lens OB2, the center are a CR is provided with a circular diffraction grating, and a convex lens portion is left therearound. Alternatively, the circular are a PR may be provided with a circular diffraction grating, and a convex lens portion may be left to the center are a thereof. Still alternatively, the center are a CR and the circular are a PR may be each provided with a circular diffraction grating, and a double focus lens may be configured. Still alternatively, a double focus lens may be an aspheric lens.

At the time of hologram recording, first of all, generated are a coherent reference light beam RB, and a signal light beam SB being a result of modulating the reference light beam RB in accordance with recording information.

The reference light beam RB and the signal light beam SB are then directed to the objective lens OB2 in such a manner as to be spatially away, coaxially, from each other. That is, as shown in FIG. 5(a), the reference light beam RB is propagated to the center are a CR on the optical axis, and the signal light beam SB is propagated circularly to the circular are a PR around the reference light beam RB with spatial separation, coaxially, from each other. The double focus lens OB2 bends the reference light beam RB and the signal light beam SB in the center are a CR and the circular are a PR, respectively. As a result, the reference light beam RB and the signal light beam SB remain spatially separate even after passing through the objective lens, and the reference light beam. RB is gathered at the close-range focal point nP located closer to the objective lens OB2, and the signal light beam SB is gathered at a long-distance focal point located away from the short-range focal point. Therefore, interference occurs at a distant location from the close-range focal point nP.

As shown in FIG. 5(b), a reflective layer 5 is disposed at the position of the close-range focal point nP for the reference light beam RB, and a hologram recording layer 7 is disposed, as a recording medium, between the objective lens OB2 and the reflective layer 5. The signal light beam SB having the circular cross section is gathered at the position of the reflective layer (long-distance focal point fP), and the reference light beam RB is gathered before the long-distance focal point fP (close-range focal point nP). Therefore, interference occurs in the vicinity of the optical axis only after these lights are reflected. If with a hologram record carrier including a hologram recording layer disposed between the close-range focal point nP and the long-distance focal point fP, recording is performed as a diffraction grating DP, and the reference light beam RB and the signal light beam SB are each a spherical wave propagating in different opposing directions. With such spherical waves, their intersection angle can be relatively large so that the multiple spacing can be reduced. As such, the hologram recording layer 7 is required to have the film thickness enough for generating a diffraction grating through intersection and interference between the signal light and the reference light after reflection.

As such, with the hologram recording system, only after the reference light beam RB and the signal light beam SB pass through the hologram recording layer 7 and are reflected, an optical interference pattern of the reference light beam RB and the signal light beam SB is stored inside as a diffraction grating DP.

As shown in FIG. 6, a specific hologram for recording includes two types of hologram recording A (reflecting reference light and reflecting signal light), and hologram recording B (incoming reference light and reflecting signal light). The hologram for reproduction also includes two types of hologram recording A (read by reflecting reference light), and hologram recording B (read by incoming reference light).

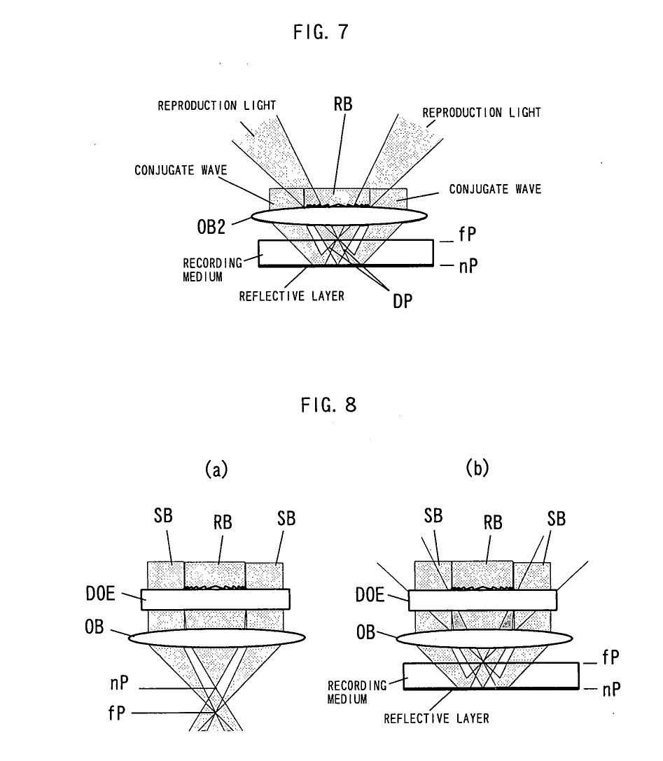

As such, with a hologram reproducing system that reproduces information from such a hologram record carrier, as shown in FIG. 7, only the reference light beam RB is supplied to the center are a CR of the objective lens OB2. After the reference light beam RB is passed through the diffraction grating DP of the hologram recording layer while being converged at the close-range focal point fP, from the diffraction grating DP, a general reproduced light and a reproduced light of a phase conjugate wave can be generated. By the objective lens OB2 being a part of the detection means, the reproduced light and the phase conjugate wave can be guided to the photodetector.

Note here that, for separating the reference light beam RB and the signal light beam SB into inner and outer portions of a luminous flux, as an alternative to the double focus objective lens OB2, as shown in FIG. 8(b), a through-light diffractive optical device DOE having a convex lens function at the center may be disposed immediately before the objective lens OB. If this is the case, the focus distance of the reference light beam RB and that of the signal light beam SB may be different from each other. That is, by an objective lens module configured by the objective lens OB and the diffractive optical device DOE, in the state of spatial separation from each other, a setting is so made that the reference light beam RB at the center is short in focus distance, and the signal light beam SB therearound is long in focus distance. As shown in FIG. 8(b), at the time of recording and reproduction, the record carrier, the objective lens, and the diffractive optical device are disposed and configured in such a manner that the reference light beam RB forms a spot (focus state) with no convergence on the reflective layer disposed on the side opposite to the light incidence side of the recording medium, and the signal light beam SB is reflected in the defocus state on this reflective surface. The recording layer of the hologram record carrier is disposed between the focal point of the reference light beam RB and the focal point of the signal light beam SB, and with such a configuration, hologram recording is performed by interference caused between these reflected signal light beam SB and reference light beam RB.

With such a configuration, at the time of light incidence, there is no overlap between the reference light beam RB and the signal light beam SB, and the signal light beam SB is so propagated as to enclose the no-modulated luminous flux (reference light beam RB) at the center portion of the circular cross section. Moreover, because the reference light beam RB is not modulated and being in a focus on the reflective surface, it can be used as a luminous flux for use for servo error detection.

At the time of hologram recording, because only the reflected signal light beam SB interferes with the reference light beam RB, no extra hologram is subjected to recording and reproduction. Moreover, because the reference light beam RB and the signal light beam SB are each a spherical wave to be propagated in different opposing directions, their intersection angle can be relatively large so that the multiple spacing can be reduced. Moreover, because the reference light beam RB can be used as a beam for use for servo error detection, there is no more need to include any other optical system for use for servo error detection.

As such, according to the embodiment, the reference light beam RB reflected at the time of reproduction is separated or forms no image so that the reference light beam RB does not reach the detector. This thus allows reception of only the reproduced light coming from any hologram needed for signal reproduction. As a result, the reproduction SN is increased, and thus the reproduction can be performed with stability.

<Hologram Record Carrier>

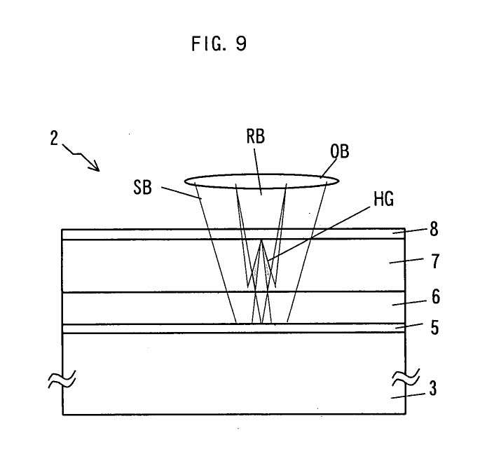

FIG. 9 shows an exemplary hologram record carrier 2. The hologram record carrier 2 is configured by a separation layer 6, a hologram recording layer 7, and a protection layer 8, which are disposed on one on the other on a substrate 3 from the side opposite to the light incidence side in the film thickness direction.

The hologram recording layer 7 stores therein an optical interference pattern of the coherent reference light beam RB and signal light beam SB for recording use as a diffraction grating (hologram). For the hologram recording layer 7, used is a light-transmissive photo sensitive material good for storage of an optical interference pattern such as photopolymer, photoisomer material, photorefractive material, holeburning material, photochromic material, and others.

The substrate 3 carrying thereon the above-described films is made of glass, polycarbonate, amorphous polyolefin, polyimide, plastic such as PET, PEN, and PES, ultraviolet-cured acrylic resin, and others.

The separation layer 6 and the protection layer 9 are each made of a through-light material, and serve to keep flat the layer accumulation configuration, and protect the hologram recording layer, for example.

When the substrate 3 is circular in shape, for tracking servo control, a track can be formed helically or concentrically, or with a plurality of partitioned spiral-circles on the center of the circular substrate. Note here that, when the substrate 3 is shaped like a card, the track may be formed parallel to the substrate. Alternatively, even with the rectangular card substrate 3, the track may be shaped helically or spiral-circularly, or concentrically on the center of gravity.

The servo control is exercised by gathering the reference light beam RB on the track of the reflective layer 5 as a spot, and using an optical system including an objective lens guiding the reflective light to a photodetector, by driving the objective lens using an actuator in accordance with any detected servo error signal. That is, a luminous flux of the reference light beam RB coming from the objective lens is so used as to come into a focus when the reflective layer 5 is located on the position of its beam waist.

<Pickup>

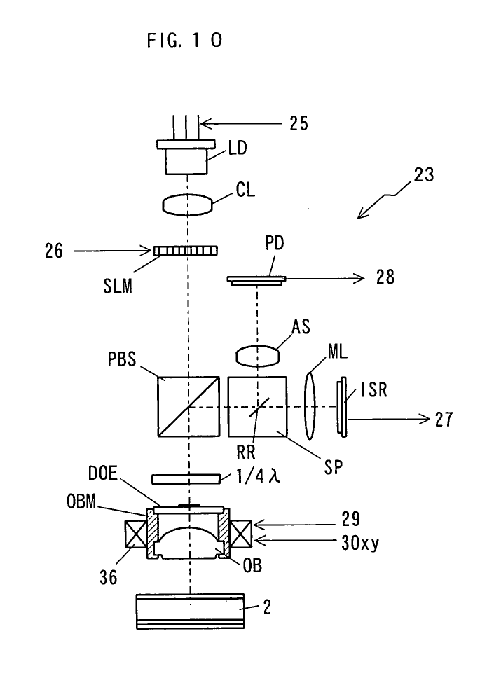

FIG. 10 shows a first embodiment of the schematic configuration of a pickup 23 for use for recording or reproduction of the hologram record carrier 2.

The pickup 23 is configured by, mainly, a hologram recording and reproduction optical system and a servo error detection system, and these systems are disposed in the cabinet (not shown) but not an objective lens module OBM and a drive system thereof.

The hologram recording and reproduction optical system includes an image sensor ISR being an array of a laser light source LD for recording and reproduction of a hologram, an objective lens module OBM, a collimator lens CL, a through-light spatial light modulator SLM, a polarization beam splitter PBS, a reference light separation prism SP, an image-forming lens ML, a CCD (Charge Coupled Device), a CMOS (Complementary Metal Oxide Semiconductor), and others, and a quarter-wave plate ¼λ.

The spatial light modulator SLM of FIG. 10 is, as shown in FIG. 11, partitioned into a center area A located in the vicinity of an optical axis including the optical axis, and a spatial light modulation are a B therearound not including the optical axis. The spatial modulation is applied to luminous fluxes passing through the spatial light modulation are a B, but no modulation is applied to luminous fluxes passing through the center are a A. That is, at the time of passage through the spatial light modulator SLM, the luminous fluxes are separated, coaxially, to the spatially-modulated signal light beam SB and the not-spatially-modulated reference light beam RB.

The spatial light modulation are a B of a through-light type is exemplified by a liquid crystal panel or others including a plurality of pixel electrodes segmented into matrixes, and has a function of electrically blocking a part of the incoming light on a pixel basis, or a function of passing through every incoming light to derive no modulation state. This spatial light modulator SLM is connected to a spatial light modulator drive circuit, and modulates or passes through the luminous fluxes so as to derive a distribution based on page data for future recording (information pattern of two-dimensional data such as light-and-dark dot pattern on a plane) so that a signal light beam SB is generated.

The center area A enclosed by the spatial light modulation are a B of the through-light matrix liquid crystal device is a through aperture hole or made of a transparent material. Alternatively, the center area A can be provided with an aperture restriction are a TCR for preventing the appearance of a rectangular aperture diffraction pattern, side lobe, and others, or for deriving a reference luminous flux with the circular cross section.

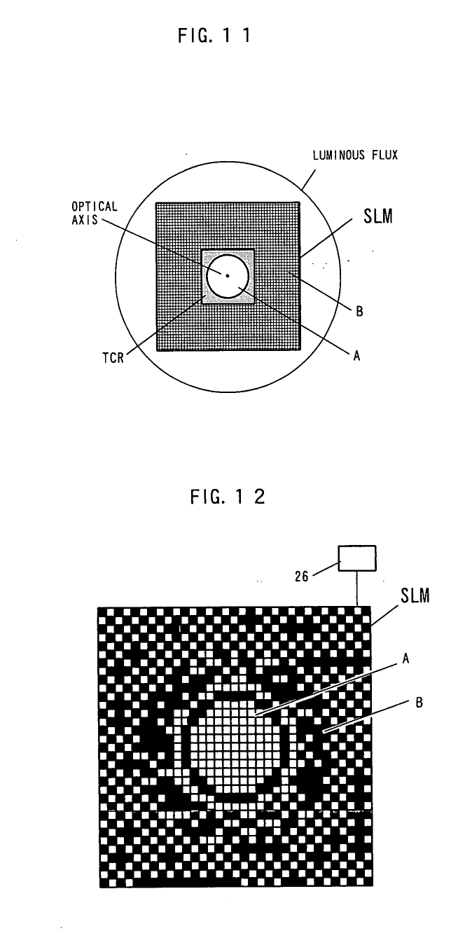

Moreover, as shown in FIG. 12, the spatial light modulator SLM may be configured entirely as a through-light matrix liquid crystal device to display, by a control circuit 26 thereof, the spatial light modulation are a B of a predetermined pattern display, and therein, the no-modulated through-light are a of the center area A.

The objective lens module OBM of FIG. 10 is a three-dimensional multi-objective lens as a combination result of, coaxially, the objective lens OB for gathering a laser light onto the recording surface, and a diffractive optical device DOE (or a convex lens). The diffractive optical device DOE includes a through-light flat plate, and a diffraction circular zone (rotation symmetry body around an optical axis) formed thereon with a plurality levels of phase differences or projections and depressions, i.e., diffraction grating with the effects of a convex lens. The objective lens OB and the diffractive optical device DOE are affixed, coaxially, to the optical axis by a hollow holder, and the diffractive optical device DOE is positioned on the side of the light source.

This diffractive optical device DOE includes a partitioned are a portion matching the spatial light modulator SLM. With the diffractive optical device DOE, the are a portion through which the reference light beam RB passes after passing through the center area A of the spatial light modulator SLM may be a Fresnel lens with the effects of a convex lens. On the other hand, the are a portion through which the signal light beam SB passes after passing through the spatial light modulation are a B of the spatial light modulator SLM may have no optical effects. Moreover, as an alternative to the diffraction grating, the portion of a convex lens may be formed as a parallel flat plate.

After passing through the diffractive optical device DOE, the luminous flux enters the objective lens OB. The objective lens OB is so set that, with the optical effects of the diffraction grating (or the portion of a convex lens), the reference light beam RB forms a spot with no convergence on the reflective layer 5 of the record carrier. On the other hand, as is not affected by the convex lens of the diffractive optical device DOE, the signal light beam SB forms a spot at a position further than that of the reference light beam RB.

The servo error detection system is for exercising servo control over the position of the reference light beam RB with respect to the hologram record carrier 2 (movement in xyz direction), and includes a laser light source LD, an objective lens module OBM, a collimator lens CL, a spatial light modulator SLM, a polarization beam splitter PBS, a reference light separation prism SP, a coupling lens AS, and a photodetector PD.

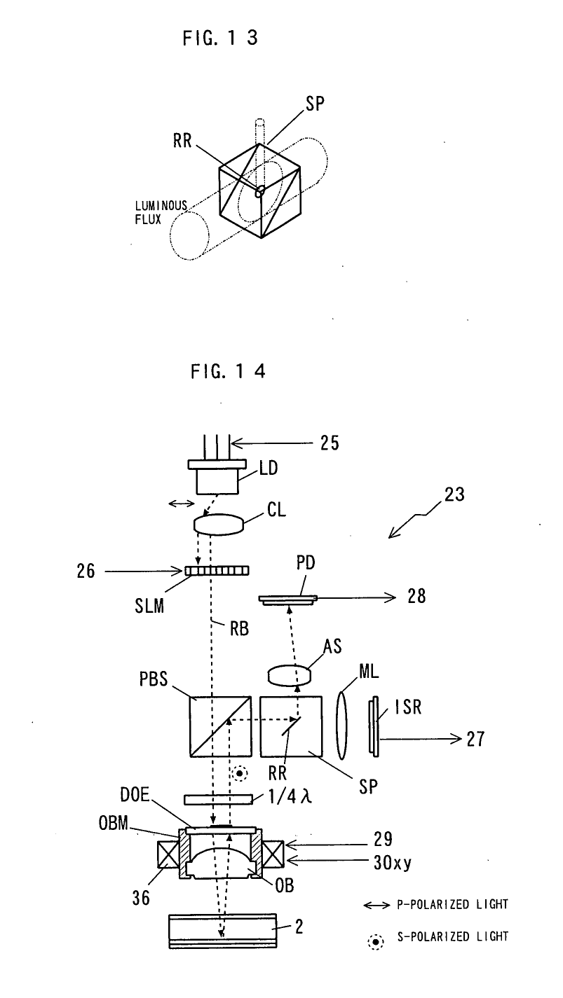

The reference light separation prism SP of FIG. 10 is, as shown in FIG. 13, a cube-shaped prism made of a transparent material, for example, and is provided with a reflective are a RR for reflecting and polarizing (vertical direction) only the reference light beam RB in the luminous flux passing in the vicinity of the optical axis, and around the reflective are a RR, the luminous flux is passed through.

The photodetector PD of FIG. 10 includes a light reception device each for focus servo use and movement servo use in x and y directions. The photodetector PD is connected to a servo signal processing circuit 28, and supplies an output signal such as focus error signal, tracking error signal, and others.

Moreover, the pickup 23 is provided with an objective lens drive section including three-axis actuator that moves, in accordance with a focus error signal, a tracking error signal, and others, the objective lens module OBM in the direction parallel to its own optical axis (z direction), in the direction parallel to the track (y direction), and in the direction vertical to the track (x direction). With the reference light beam RB, servo control is exercised to position the carrier 2, and through the servo control over positioning, by an error signal being a result of computation based on the output of the photodetector PD, the three-axis actuator (objective lens drive section 36) that can drive the objective lens module OBM along three axes of x, y, and z directions is driven.

As shown in FIG. 10, these optical components are so disposed that the optical axes of luminous fluxes coming from a light source (an alternate long and short dashed line) each extend to the recording and reproduction optical system and the servo system, and substantially overlap in any common system.

<Operation of Pickup>

FIG. 14 shows an initial servo operation.

When the hologram record carrier 2 is attached to an apparatus, generally, the servo error detection system executes a servo operation. At the hologram recording and reproduction, a divergence coherent light of a P polarized light (double-headed arrow indicating being parallel in the drawing) coming from a laser light source LD is collimated by the collimator lens CL, and the resulting collimated luminous flux is directed to the spatial light modulator SLM (beam being a part of the luminous flux is indicated by broken lines). The reference light beam RB for servo control is generated by the spatial light modulator SLM.

As shown in FIG. 14, the reference light beam RB in the vicinity of the optical axis not blocked in the spatial light modulation are a of the spatial light modulator SLM passes through the polarization beam splitter PBS and the quarter-wave plate ¼λ, and the resulting circular polarized light is directed to the hologram record carrier 2 by the objective lens module OBM. The reflective light coming from the hologram record carrier 2 (light returning to the objective lens module OBM) passes through the quarter-wave plate ¼λ on the path similar to the path used at the time of heading. The resulting S polarized light (black circle enclosed by a broken line indicating the vertical direction in the drawing) is split by the polarization beam splitter PBS, and then enters the reference light separation prism SP. The reference light separation prism SP reflects only the portion exposed to the reference light in the reflective are a RR, and is polarized from the optical axis in the vertical direction, for example, and therearound, the luminous flux is passed through. The reference light beam RB reflected thereby passes through the coupling lens AS, and then enters the optical system for use for servo error detection along the normal of the light reception surface of the photodetector PD.

Because the reference light beam RB is forming a spot on the reflective film of a record carrier, by any signal derived by the servo error detection optical system and the photodetector PD, a servo error signal (focus signal and tracking signal) can be derived by the methods adopted by any existing optical disk pickup (astigmatism and push-pull).

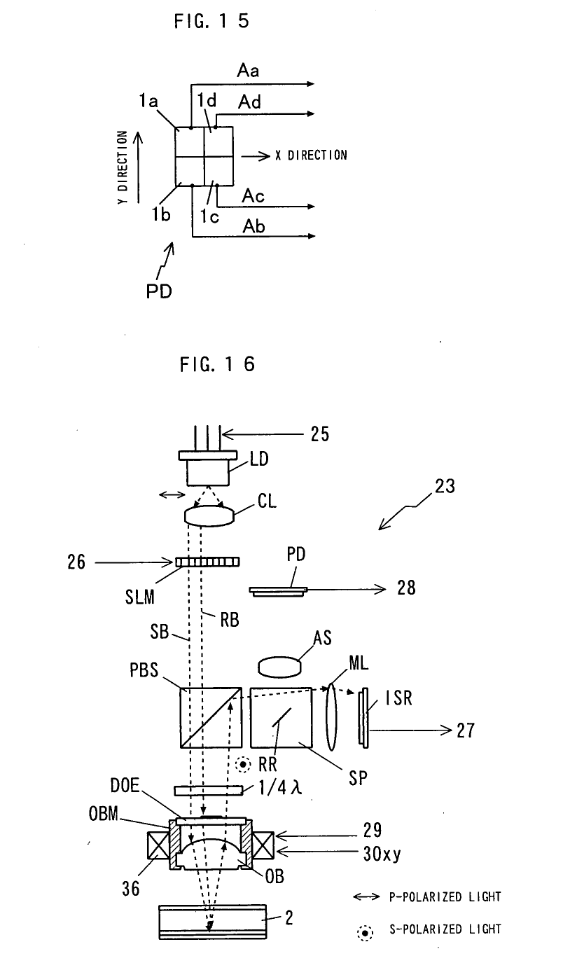

If with astigmatism, for example, with the coupling lens AS as an astigmatism optical device, one of the photodetectors PD at the center may be configured by light reception devices 1a to 1d with a light reception surface divided into 4 equal parts for beam reception use as shown in FIG. 15. The direction of the 4-division line is corresponding to the x and y directions. The photodetector PD is, when being in focus, so set that a spot of the reference light is circular around the intersection center of the divided light reception devices 1a to 1d.

In accordance with the output signals of the light reception devices 1a to 1d of the photodetector PD, respectively, the servo error signal processing circuit generates various types of signals. Assuming that the output signals of the light reception devices 1a to 1d are Aa to Ad in this order, a focus error signal FE is calculated as FE=(Aa+Ac)−(Ab+Ad), and a tracking error signal TE is calculated as TE=(Aa+Ad)−(Ab+Ac).

FIG. 16 shows the recording operation.

A divergence coherent light of a P polarized light directed from the laser light source LD is collimated by the collimator lens CL, and the resulting collimated luminous flux enters the spatial light modulator SLM (beam being a part of the luminous flux is indicated by broken line). After passing through the spatial light modulator SLM, the luminous flux is separated into the signal light beam SB having been passed through the spatial light modulation are a being away from the optical axis and being diffracted by the spatial modulation pattern for recording, and the no-diffracted reference light beam RB having been passed through the center area. The signal light beam SB and the reference light beam RB of these luminous fluxes pass through the quarter-wave plate ¼λ via the polarization beam splitter PBS, and are converted into circular polarized lights. The results are then gathered to the hologram record carrier 2 by the objective lens module OBM.

The record carrier is configured by a substrate, a reflective film, a separation layer, a hologram recording layer, and a protection layer in this order from the side away from the objective lens OB. The reference light beam RB forms a spot on the reflective film of the hologram record carrier 2 by the diffractive optical device DOE and the objective lens OB.

The signal light beam SB enters the reflective film 5 after defocusing, and is directed toward the front of the reflective film (side of the objective lens OB). By the servo operation described above, the reference light beam RB and the signal light beam SB are so controlled that the hologram recording layer comes between the focus position of the reference light beam RB and the focus position of the signal light beam SB.

After being reflected by the reflective layer, the luminous fluxes of the reference light beam RB and the signal light beam SB generate an interference pattern in the hologram recording layer 2 so that a hologram is recorded.

After being reflected and passing through the hologram recording layer, the reference light beam RB and the signal light beam SB pass through the objective lens module OBM and the quarter-wave plate ¼λ. The resulting S polarized light is split by the polarization beam splitter PBS, and is directed to the reference light separation prism SP. The reference light beam RB is split by the reference light separation prism SP, and then is put into the servo operation. The signal light beam SB passes through the reference light separation prism SP, and reaches the image-forming lens ML. The image-forming lens ML has the effects of correcting defocusing of the record carrier on the reflective layer, and with the image-forming lens ML, the signal light beam SB is image-formed on the image sensor ISR with no distortion. By observing this image, the spatial light modulator SLM can be checked for its modulation state.

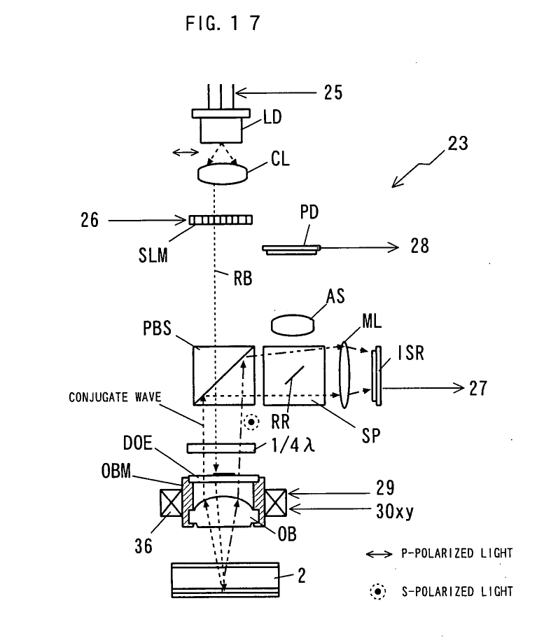

FIG. 17 shows the reproduction operation.

The divergence coherent light of the P polarized light directed from the laser light source LD is collimated by the collimator lens CL, and the resulting collimated luminous flux enters the spatial light modulator SLM. After passing through the center are a on the optical axis, the reference light beam RB not blocked by the spatial light modulation are a of the spatial light modulator SLM passes through the polarization beam splitter PBS and the quarter-wave plate ¼λ, and the resulting circular polarized light is directed onto the hologram record carrier 2 by the objective lens module OBM. From the diffraction grating of the hologram recording layer, a reproduced light is generated. The reproduced light being in defocus state becomes an S polarized light by the quarter-wave plate ¼λ after passing through the objective lens module OBM in the path same as that of the signal light, and then is reflected by the polarization beam splitter PBS. The reproduced light passes through the reference light separation prism SP, and reaches the image-forming lens ML. With the image-forming lens ML, the reproduced light is image-formed on the image sensor ISR with no distortion. With this image sensor ISR, the signal recorded on the hologram is reproduced.

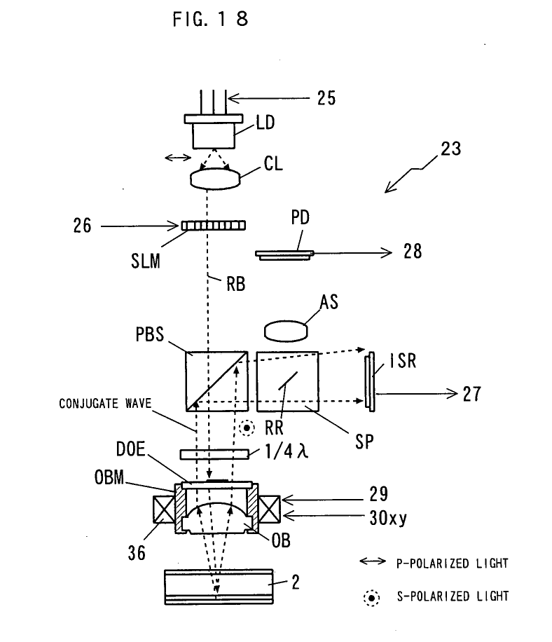

Herein, through irradiation of the reference light beam RB to the hologram recording layer of the hologram record carrier 2, a phase conjugate wave (vary in heading direction with 180-degree difference) is generated as a reproduced light. Such a conjugate wave is reflected by the reflective layer, and returns the optical path same as that of the incoming signal light at the time of recording. As is returned from the objective lens module OBM as a collimated light, such a phase conjugate wave passes through the quarter-wave plate ¼λ and the polarization beam splitter PBS, and then the reference light separation prism SP before reaching the image-forming lens ML. However, with the image-forming lens ML, no image is formed on the image sensor ISR. This is because the image-forming lens ML is so configured as to image-form one of the reproduced lights. Moreover, as shown in FIG. 18, with no image-forming lens ML, it can be configured as a reproduction optical system of image-forming only the conjugate wave on the image sensor ISR.

### PICKUP OF SECOND EMBODIMENT

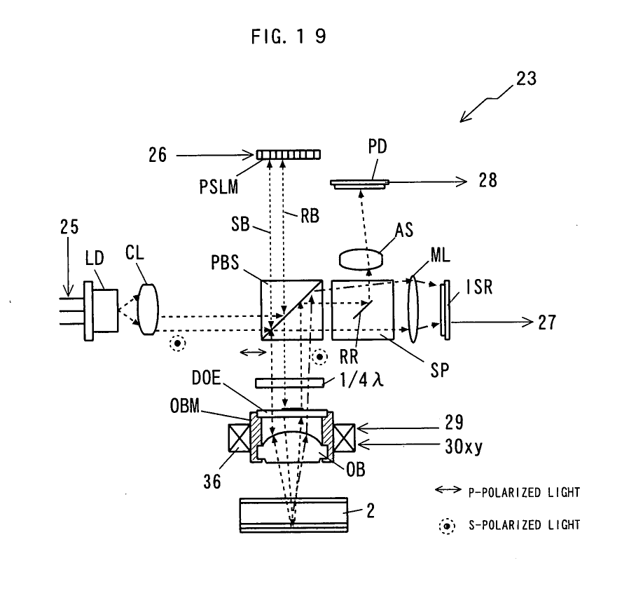

FIG. 19 shows the configuration of a pickup of a second embodiment.

The pickup of the second embodiment uses a polarization spatial light modulator PSLM of a reflective-type as an alternative to the spatial light modulator SLM of a through-light type, and an S polarized light from a laser light source LD is directed to the polarization spatial light modulator PSLM via a polarization beam splitter PBS so that its reflected light is used. These are the only differences, and the remaining is the same as the above-described pickup 23.

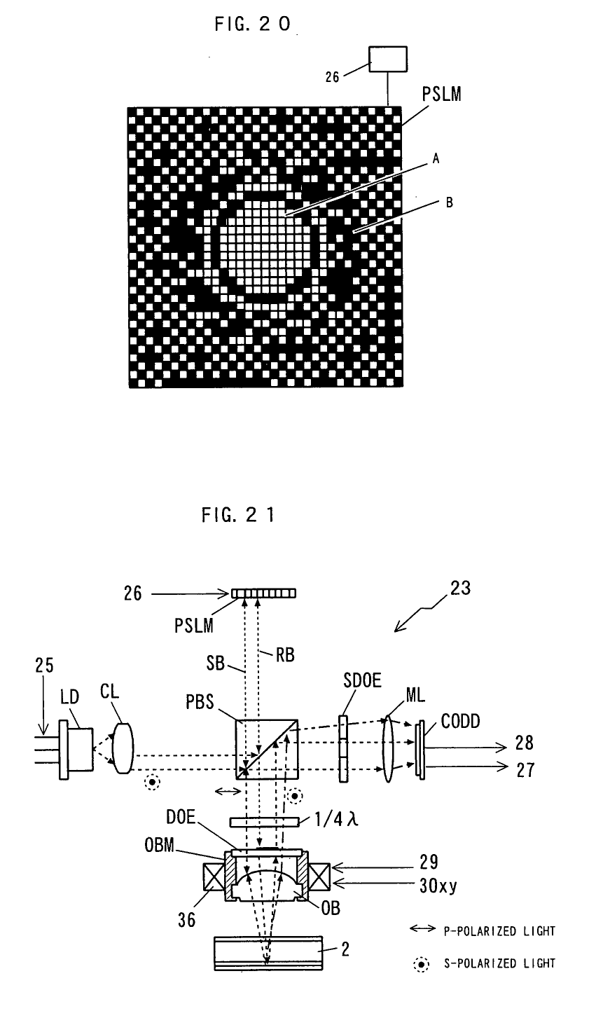

As shown in FIG. 20, the polarization spatial light modulator PSLM is a so-called LCOS (Liquid Crystal On Silicon) apparatus in which the are a is divided into a center area A in the vicinity of an optical axis including the optical axis, and a spatial light modulation are a B therearound not including the optical axis. The luminous flux reflected by the spatial light modulation are a B is subjected to modulation of P or S polarization, and the luminous flux reflected by the center area A is subjected to modulation of only P polarization. That is, when the polarization spatial light modulator PSLM reflects the luminous flux, the luminous flux is separated, coaxially, into the spatially-modulated signal light beam SB and the not-spatially-modulated reference light beam RB.

The polarization spatial light modulator PSLM is exemplified by a liquid crystal panel or others including a plurality of pixel electrodes segmented into matrixes, and has a function of electrically polarizing a part of the incoming light on a pixel basis. This polarization spatial light modulator PSLM is connected to a spatial light modulator drive circuit, and modulates the polarized luminous fluxes so as to derive a distribution based on page data for future recording (information pattern of two-dimensional data such as light-and-dark dot pattern on a plane) so that a signal light beam SB including a predetermined polarization component is generated. Moreover, it is possible to keep the same polarized light by light incidence and reflection. The center area A enclosed by the spatial light modulation are a B is delimited by being put in the no-modulation state.

The divergence coherent light of an S polarized light directed from the laser light LD is collimated, and then enters the polarization beam splitter PBS. The collimated luminous flux is reflected, and then enters the polarization spatial light modulator PSLM. In the polarization spatial light modulator PSLM, the spatial modulation are a is set to the outer are a being the spatial light modulation are a B, and the no-modulation are a is set to the inner are a being the center area A, and is so driven that the inner luminous flux becomes entirely a P polarized light. The luminous flux in the center area A is the reference light. On the other hand, in the outer spatial light modulation are a B, any given page data modulates the polarization state to S polarization and P polarization. The luminous flux in this are a is the signal light beam SB.

The reference light that is P-polarized by the polarization spatial light modulator PSLM passes through the polarization beam splitter PBS, and then the quarter-wave plate ¼λ, the diffractive optical device DOE, and the objective lens OB, and comes into focus on the reflective layer on the record carrier.

From the signal light beam SB modulated by the polarization spatial light modulator PSLM, only the P polarization component passes through the polarization beam splitter PBS, and reaches the record carrier. The recording and reproduction in the record carrier are the same as the above-described embodiment.

### PICKUP OF THIRD EMBODIMENT

FIG. 21 shows the configuration of a pickup of a third embodiment.

The pickup of the third embodiment uses an optical device SDOE for servo detection use and a multi photodetector apparatus CODD for signal detection use as alternatives to the coupling lens AS, the photodetector PD, the reference light separation prism SP, and the image sensor ISR. This is the only difference, and the remaining is the same as the second embodiment.

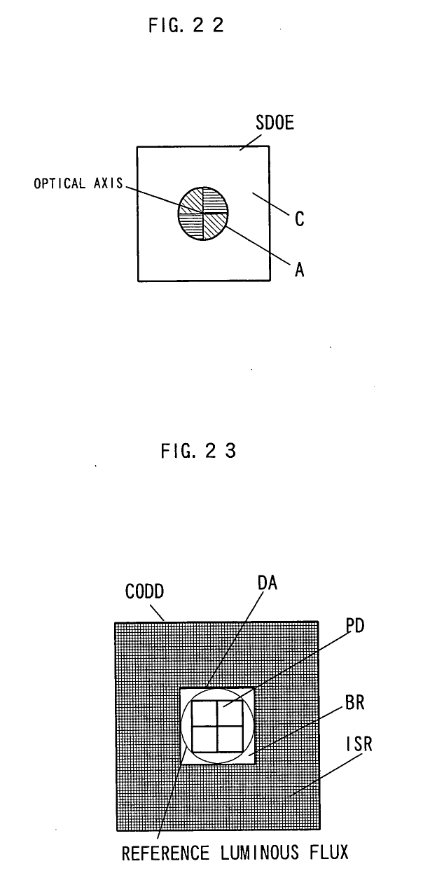

As shown in FIG. 22, the optical device SDOE for servo detection use is divided into a center area A including an optical axis and a neighboring are a C therearound not including the optical axis. The center area A is configured as astigmatism generation means, e.g., as a diffraction grating, and a luminous flux passing therethrough suffers from astigmatism. When a light reception surface of a four-way split photodetector is provided in the downstream, a spot with astigmatism is formed. In the neighboring are a C, a luminous flux passing therethrough is passed through with no modulation. As such, the optical device SDOE for servo detection use separates at the time of light passage therethrough, coaxially, a signal light or a reproduced light from the reference light for servo detection use.

As shown in FIG. 23, the multi photodetector apparatus CODD for signal detection use is formed with a photodetector PD, e.g., the light reception surface of a four-way split photodetector, capable of receiving a normal servo error signal in a center are a DA including the optical axis, and servo error generation. The neighboring are a DC carries therein an image sensor portion ISR for receiving a reproduced light. Although the light reception surface of the photodetector PD is configured by a PIN photodiode, excited electron by an incident light around the light reception surface will have a large DC offset, and thus a shielding section for light shielding around the light reception surface, or a buffer are a BR for releasing electrons with grounding may be provided.

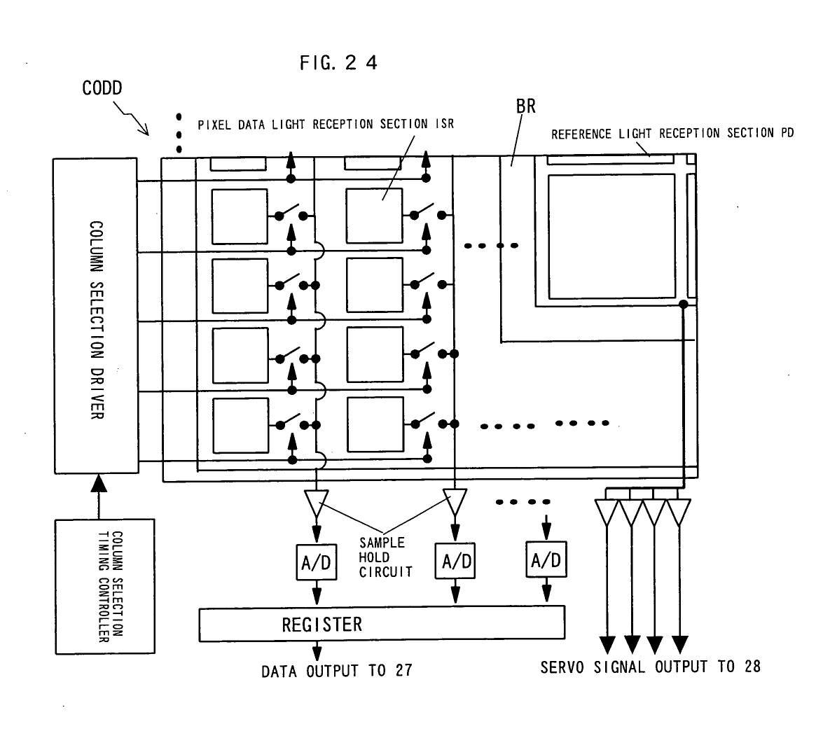

Moreover, as shown in FIG. 24, the photodetector PD for servo signal generation use of the center portion DA of the multi photodetector apparatus CODD for signal detection use is connected only with a high-speed 1/V amplifier similarly to a general light reception device for optical disk use, and the neighboring are a DC is connected with a circuit having a function of integration, or a circuit having a function of data processing. Reading of the reproduction data is performed in an intermittent manner, and reading of a servo signal and an address signal is performed in a sequential manner. Therefore, with some design ideas to the circuit configuration in the light reception section, it becomes possible to execute processing in the same light reception section having various different characteristics.

Note that, in the pickup of the third embodiment of FIG. 21, the neighboring are a C in the optical device SDOE for servo detection use may be configured not only for passing through luminous fluxes but also for image-forming a reproduced light or a conjugate light as a diffractive optical device in the image sensor portion ISR in the neighboring are a DC in the downstream. With this configuration, the image-forming lens ML may not be provided.

### PICKUP OF FOURTH EMBODIMENT

In the above-described embodiments, using a double focus objective lens, an objective lens, and an objective lens module being a diffractive optical device, a reference light having been passed through the objective lens is so configured as to be gathered at a close-range focal point closer to the objective lens than a long-distance focal point. The optical device with such a function may serve enough if it is disposed on the optical axis of an irradiation optical system. Alternatively, not at a position closer to the objective lens, an optical device having a function of gathering a light at a close-range focal point by an objective lens may be attached to the center are a in a through-light matrix liquid crystal apparatus of the spatial light modulator SLM in the first embodiment of FIG. 10, for example.

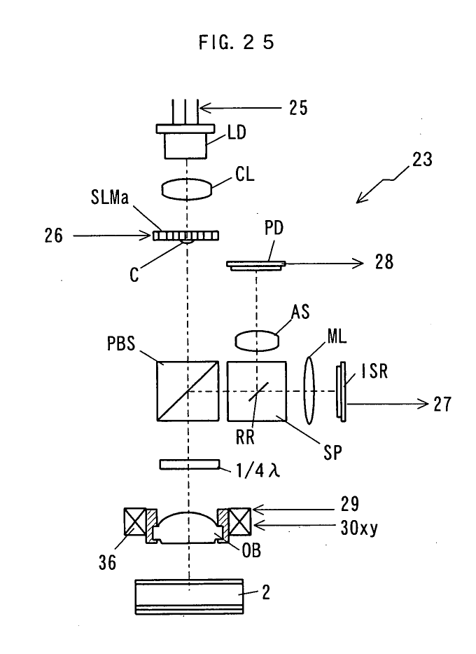

The pickup of the fourth embodiment of FIG. 25 is the same as the pickup 23 of the first embodiment described above except that the objective lens module OBM and the spatial light modulator SLM in the first embodiment of FIG. 10 are replaced with a simple objective lens OB, and a spatial light modulator SLMa being a piece with a convex lens optical device. The part of the diffractive optical device DOE or the part of the convex lens of the objective lens module OBM is incorporated into the through-light spatial light modulator SLM, and the result is the spatial light modulator SLMa being a piece with the convex lens optical device.

As shown in FIG. 26, the spatial light modulator SLMa being a piece with the convex lens optical device is divided into a convex lens optical device section C in a center are a being in the vicinity of an optical axis and including the optical axis, and a spatial light modulation are a B therearound not including the optical axis. The spatial modulation is applied to luminous fluxes passing through the spatial light modulation are a B, and luminous fluxes passing through the convex lens optical device section C are not subjected to modulation, and are separated coaxially into the signal light beam SB and the reference light beam RB. The spatial light modulator SLMa is under the control of the control circuit 26. As such, as a through-light matrix liquid crystal device including a no-modulated convex lens at the center, the spatial light modulator SLM itself can be configured as a spatial light modulation are a B of predetermined pattern display therearound, or the convex lens may be disposed through attachment in the vicinity of the center of the spatial light modulator.

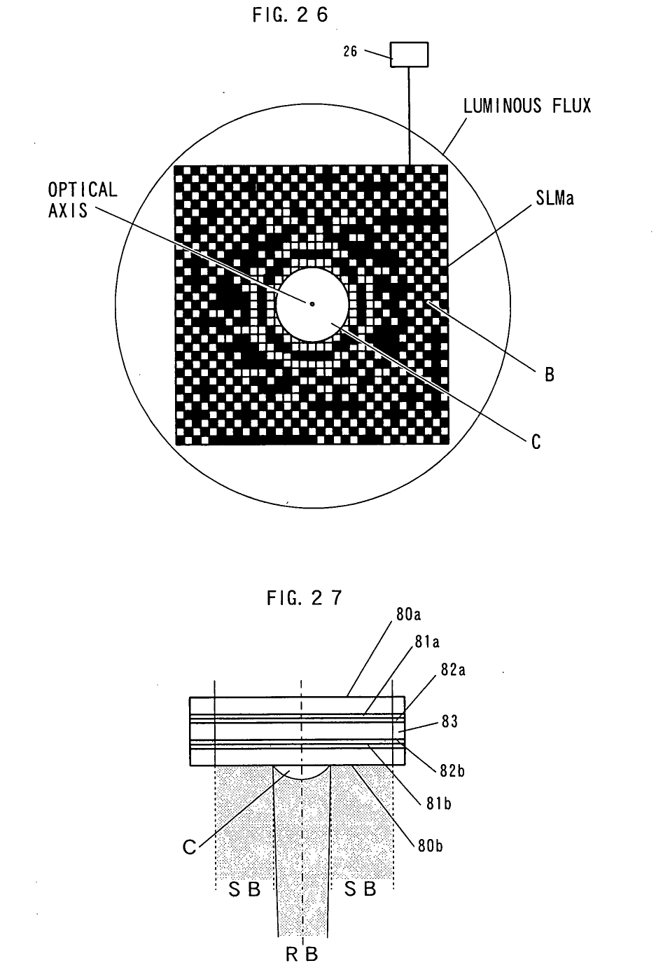

FIG. 27 shows the cross-section of the spatial light modulator SLMa being a piece with an optical device. The optical device section C is so set that the refracted reference light beam RB is directed to the objective lens OB, and together with the optical effects thereof, a spot is formed with no aberration on the reflective film 5 of a record carrier. On the other hand, because the signal light beam SB is not affected by the convex lens of the optical device section C, it forms a spot at a position further from that formed by the reference light beam RB. The spatial light modulator portion is configured by a liquid crystal layer 83 sandwiched between transparent electrodes 81a and 81b and orientation films 82a and 82b formed in this order to the inner surfaces of a pair of opposing glass substrates 80a and 80b.

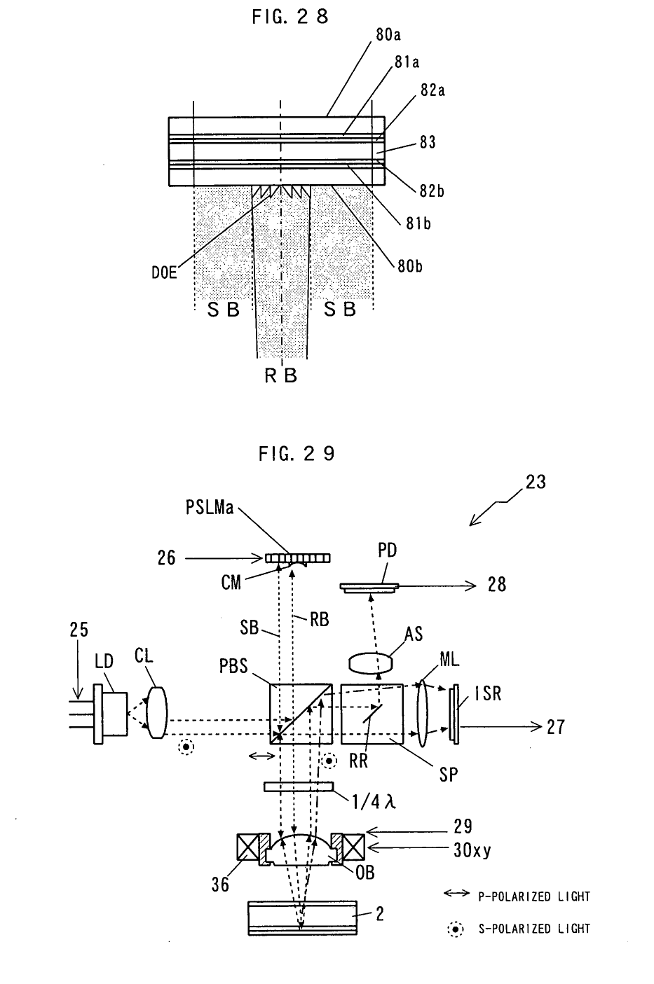

As shown in FIG. 28, as an alternative to a convex lens using for the optical device section C of the spatial light modulator SLMa being a piece with a convex lens optical device, a through-light diffractive optical device DOE may be used. The diffractive optical device DOE includes a diffraction circular zone (rotation symmetry body around an optical axis) formed on a glass substrate 80b with a plurality levels of phase differences or projections and depressions, i.e., diffraction grating.

As such, by configuring an optical device in which the focus positions in a hologram recording layer vary for a reference light and a signal light to be a piece with a spatial modulation device for spatially modulating a signal light, the reference light are a and the signal light are a in the spatial light modulator SLMa can be matched to the focal position change effect are a of the optical device such as a convex lens. Moreover, it is possible to prevent any position displacement therebetween that will cause a problem when the optical devices such as an objective lens and a convex lens are configured as a piece.

FIG. 29 shows the configuration of a pickup of a modified example of the fourth embodiment.

The pickup of the modified example in the embodiment is the same as the pickup described above except that the pickup objective lens module OBM and the reflective polarization spatial light modulator PSLM in the second embodiment of FIG. 19 are replaced with a simple objective lens OB and a reflective polarization spatial light modulator PSLMa being a piece with a concave mirror optical device. Using the reflective polarization spatial light modulator PSLM, an S polarized light from a laser light source LD is directed to the polarization spatial light modulator PSLM via a polarization beam splitter PBS, and the reflected light is used.

On the surface of the reflective polarization spatial light modulator (e.g., LCOS), a concave mirror optical device section CM matching the reference light are a is formed. Moreover, as an alternative to a concave mirror formed on the reflective center are a of the reflective polarization spatial light modulator, it is possible to include a diffractive optical device having the effects of a concave mirror. This enables to provide, with no position displacement, the optical effects (light gathering effects) to the reference light are a defined by the reflective polarization spatial light modulator SLMa.

In any of the embodiments, a reference light is separated from a signal light concentrically and spatially by the optical system in its entirety, and a focal point of the reference light is so set as to be further from a focal point of the signal light in the optical system in its entirety. The focal point of the reference light is focused on the reflective film of a record carrier, and the signal light is defocused on the reflective film, i.e., long-distance focal point, and a hologram recording layer is disposed between the focal points. This enables to simplify the configuration of a pickup.

<Hologram Device>

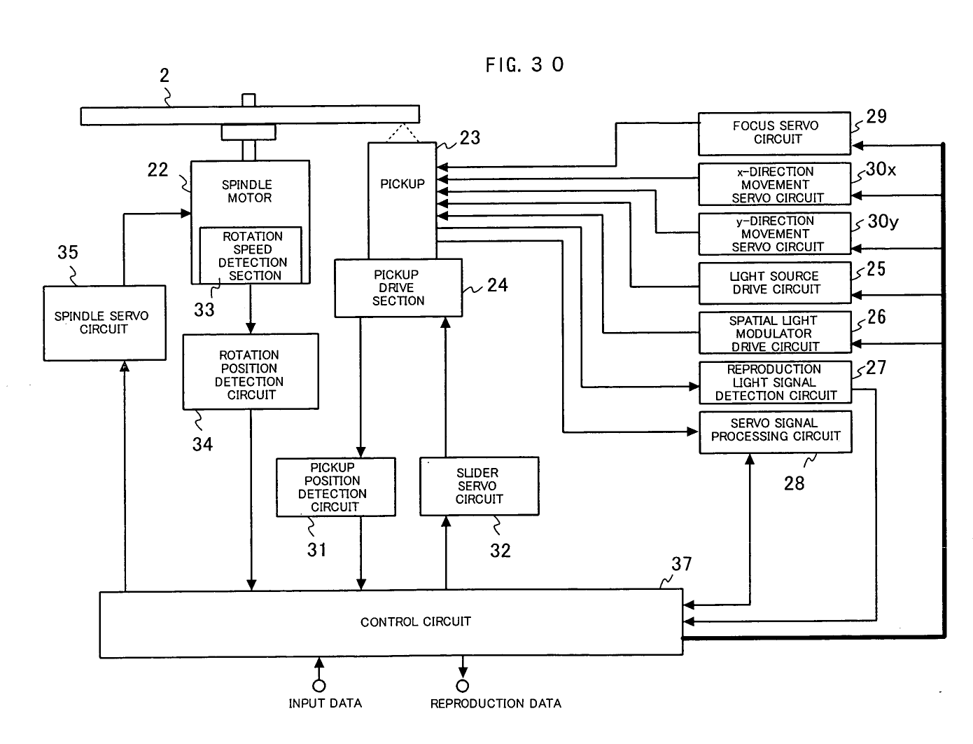

FIG. 30 shows an exemplary schematic configuration of a hologram device for recording and reproducing information of a disk-shaped hologram record carrier to which the present invention is applied.

The hologram device of FIG. 30 is provided with: a spindle motor 22 for rotating the disk of the hologram record carrier 2 by a turntable; the pickup 23 for reading a signal from the hologram record carrier 2 using a luminous flux; a pickup drive section 24 for keeping hold of the pickup and moving it in the radius direction (x direction); a light source drive circuit 25; the spatial light modulator drive circuit 26; a reproduced light signal detection circuit 27; a servo signal processing circuit 28; a focus servo circuit 29; an x-direction movement servo circuit 30x, a y-direction movement servo circuit 30y, a pickup position detection circuit 31 connected to the pickup drive section 24 for detection of a position signal of the pickup; a slider servo circuit 32 connected to the pickup drive section 24 for supply of a predetermined signal thereto; a rotation speed detection section 33 connected to the spindle motor 22 for detection of a rotation speed signal of the spindle motor; a rotation position detection circuit 34 connected to the rotation speed detection section for generating a rotation position signal of the hologram record carrier 2; and a spindle servo circuit 35 connected to the spindle motor 22 for supply of a predetermined signal thereto.

The hologram device includes a control circuit 37, and the control circuit 37 is connected to the light source drive circuit 25, the spatial light modulator drive circuit 26, the reproduced light signal detection circuit 27, the servo signal processing circuit 28, the focus servo circuit 29, the x-direction movement servo circuit 30x, the y-direction movement servo circuit 30y, the pickup position detection circuit 31, the slider servo circuit 32, the rotation speed detection section 33, the rotation position detection circuit 34, and the spindle servo circuit 35. Based on signals coming from these circuits, the control circuit 37 exercises, via these drive circuits, control over the pickup, e.g., focus servo control, x- and y-direction movement servo control, and reproduction position (position in x- and y directions) control. The control circuit 37 is a microcomputer equipped with various types of memories, and exercises control over the apparatus in its entirety. In accordance with the operation input by a user from an operation section (not shown) and the current operation status of the apparatus, the control circuit generates various types of control signals, and is connected to a display section (not shown) for displaying thereon the operation status or others for the user.

The light source drive circuit 25 connected to the laser light source LD goes through output adjustment of the laser light source LD in such a manner that the intensity of the outgoing luminous fluxes is increased at the time of hologram recording, and decreased at the time of reproduction.

The control circuit 37 goes through processing such as encoding of data for hologram recording provided from the outside, and exercises control over the recording sequence for a hologram with a supply of a predetermined signal to the spatial light modulator drive circuit 26. Based on a signal from the reproduced light signal detection circuit 27 connected to the image sensor ISR, the control circuit 37 goes through a demodulation and error correction process so that the data recorded on the hologram record carrier is reconstructed. Moreover, the control circuit 37 reproduces information data by subjecting any reconstructed data to a decoding process, and outputs the result as reproduction information data.

Moreover, the control circuit 37 exercises control in such a manner that a hologram is formed at regular intervals to be able to record a hologram for recording at regular intervals (multiplex spacing).

In the servo signal processing circuit 28, a focusing drive signal is generated from a focus error signal, and this is supplied to the focus servo circuit 29 via the control circuit 37. In response to the drive signal, the focus servo circuit 29 drives the focusing portion of the objective lens drive section 36 equipped to the pickup 23, and the focusing portion is so operated as to adjust the focus position of a light spot to be irradiated to the hologram record carrier.

Moreover, in the servo signal processing circuit 28, x- and y-direction movement drive signals are generated, and these are supplied to the x-direction movement servo circuit 30x and the y-direction movement servo circuit 30y, respectively. The x-direction movement servo circuit 30x and the y-direction movement servo circuit 30y drive the objective lens drive section 36 equipped to the pickup 23 in accordance with the x- and y-direction movement drive signals. Accordingly, the objective lens is driven by the amount corresponding to the drive current by the drive signals in the x, y, and z directions so that the light spot for exposure to the hologram record carrier is changed in position. As such, with the fixed relative position of a light spot with respect to a hologram record carrier in motion at the time of recording, the formation time for a hologram can be kept.

The control circuit 37 generates a slider drive signal based on a position signal coming from the operation section or the pickup position detection circuit 31, or an x-direction movement error signal coming from the servo signal processing circuit 28. These signals are supplied to the slider servo circuit 32. The slider servo circuit 32 moves, via the pickup drive section 24, the pickup 23 in the disk radius direction in accordance with the drive current by the slier drive signal.

The rotation speed detection section 33 detects a frequency signal indicating the current rotation frequency of the spindle motor 22 for use to rotate the hologram record carrier 2 using the turntable, and generates a rotation speed signal indicating the spindle rotation speed corresponding thereto for supply to the rotation position detection circuit 34. The rotation position detection circuit 34 generates a rotation position signal, and supplies it to the control circuit 37. The control circuit 37 generates a spindle drive signal, and supplies it to the spindle servo circuit 35 for control over the spindle motor 22 so that the hologram record carrier 2 is rotated and driven.

<Another Hologram Record Carrier>

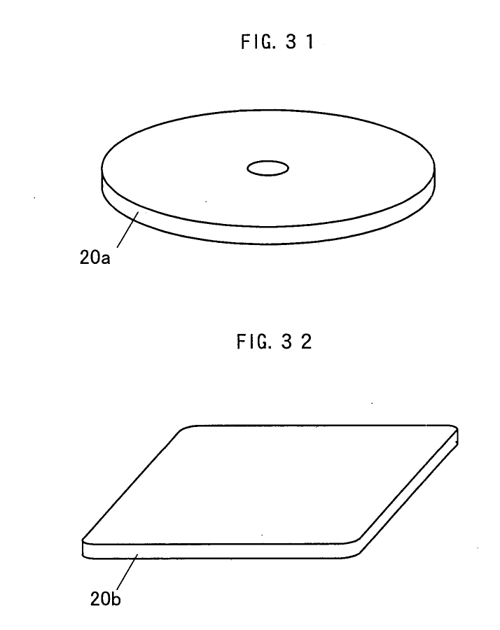

In the embodiment, a hologram record carrier 20a in the shape of a disk as shown in FIG. 31 is mainly described. The shape of the hologram record carrier is not restrictive to the disk shape, and alternatively, a rectangular flat plane optical card 20b made of plastic or others as shown in FIG. 32 will also do.

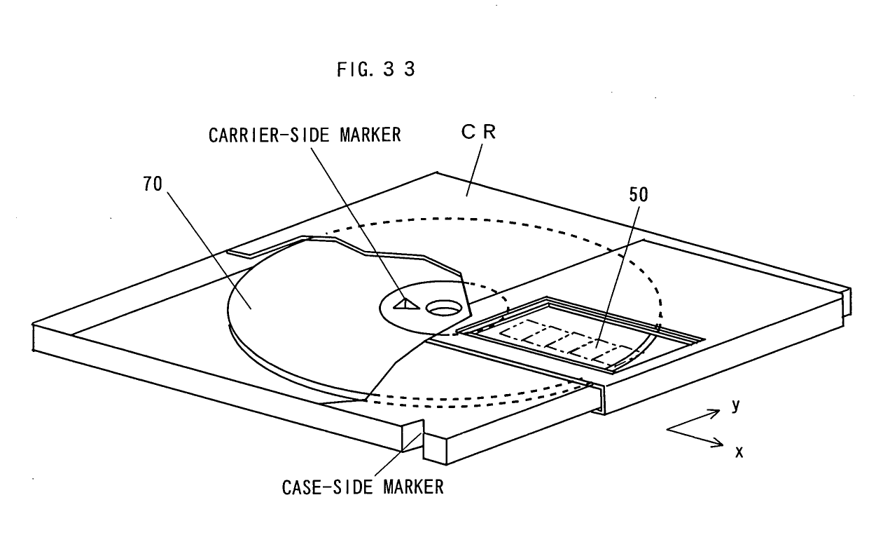

In the above embodiment, described is a hologram record carrier in which a hologram recording layer and a reflective layer are disposed on one on the other as a piece. In another embodiment, as shown in FIG. 33, a hologram record carrier may be configured in which a reflective section 50 and a record carrier 70 of the hologram recording layer are separately provided.

With this being the case, as shown in FIG. 33, the disk-shaped record carrier 70 may be housed in a case CR, and the reflective section 50 may be provided to the inner wall surface thereof. That is, the reflective section 50 is disposed to the side opposite to the light exposure surface of the record carrier 70 with a space therefrom. Note that, a clamp joint section at the center of the disk-shaped record carrier 70 is provided with a carrier-side position marker for engagement with the clamp, and the case CR may be provided with a case-side position marker for fixation to the apparatus, thereby enabling accurate alignment between the carrier and the apparatus.

### ANOTHER EMBODIMENT

Described above is the embodiment in which a signal light is propagated around a reference light, and irradiated to be in a defocus state on the reflective layer in a case where the focal point of the signal light is further from an objective lens than the focal point of a reference light. Alternatively, when the focal point of the signal light is located before the focal point of the reference light, such a defocus state can be achieved.

FIG. 34 shows an exemplary configuration of an objective lens optical system disposed on an optical axis of another embodiment.

A double focus lens OB3 is configured by a center are a CR including the optical axis, and a circular are a PR therearound, and is a condenser with which a signal light in the circular are a PR is gathered at a close-range focal point nP (second focal point), and a reference light in the center are a CR is gathered at a long-distance focal point fP (first focal point). In the double focus lens OB3, a circular diffraction grating is disposed at the center are a CR of the refractive surface, and a convex lens portion is left therearound. The reverse configuration is possible, or a double focus lens may be configured by providing a circular diffraction grating to both the center are a CR and the circular are a PR. Moreover, a double focus lens may be an aspheric lens.

At the time of hologram recording, first of all, generated are a coherent reference light beam RB and a signal light beam SB being a result of modulating the reference light beam RB in accordance with recording information.

Thereafter, the reference light beam RB and the signal light beam SB are directed to the objective lens OB3 in such a manner as to be spatially away, coaxially, from each other. That is, as shown in FIG. 34(a), the reference light beam RB is propagated to the center are a CR on the optical axis, and the signal light beam SB is propagated circularly to the circular are a PR around the reference light beam RB with spatial separation, coaxially, from each other. The double focus lens OB3 bends the reference light beam RB and the signal light beam SB in the center are a CR and the circular are a PR, respectively. As a result, the reference light beam RB and the signal light beam SB spatially remain separate even after passing through the objective lens, and the signal light beam SB is gathered at a close-range focal point nP (second focal point) located closer to the objective lens OB3, and the reference light beam RB is gathered at a long-distance focal point fP (first focal point) located further than the short-range focal point.

As shown in FIG. 34(b), the reflective layer 5 is disposed at the position of the long-distance focal point fP of the reference light beam RB, and the hologram recording layer 7 is disposed between the objective lens OB3 and the reflective layer 5. Because the signal light beam SB having the circular cross section is gathered before the reflective layer 5, the light is defocused on the reflective layer 5, and the reflected signal light beam SB does not intersect the reference light beam RB so that no interference occurs. Because the incoming signal light beam SB and the reference light beam RB have a relatively large angle of intersection, the multiple spacing can be reduced.

As such, in the hologram recording system in this embodiment, only an incoming signal light beam SB forms an optical interference pattern with the reference light beam RB for storage inside as a diffraction grating DP.

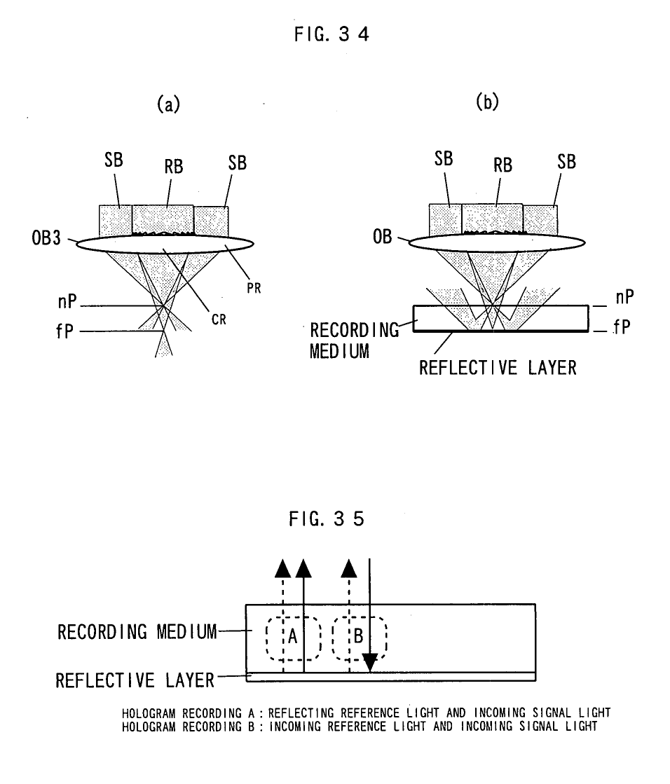

As shown in FIG. 35, a specific hologram for recording includes two types of hologram recording A (reflecting reference light and incoming signal light), and hologram recording B (incoming reference light and incoming signal light). The hologram for reproduction also includes two types of hologram recording A (read by reflecting reference light), and hologram recording B (read by incoming reference light).

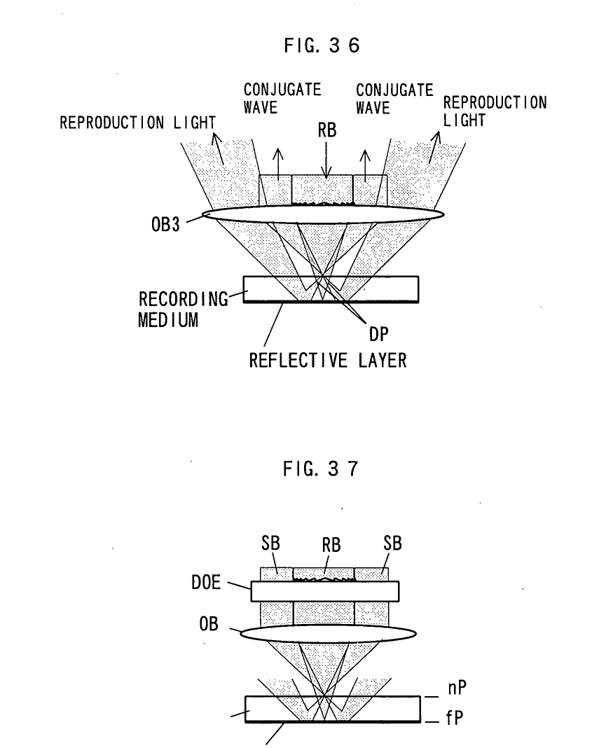

As such, with a hologram reproducing system that reproduces information from such a hologram record carrier, as shown in FIG. 36, only the reference light beam RB is supplied to the center are a CR of the objective lens OB3. After the reference light beam RB is passed through the diffraction grating DP of the hologram recording layer while being converged at the reflective layer 5 (long-distance focal point fP), from the diffraction grating DP, a general reproduced light and a reproduced light of a phase conjugate wave can be generated. By the objective lens OB3 being a part of the detection means, the reproduced light and the phase conjugate wave can be guided to the photodetector.

If with the reproduced light of a phase conjugated wave, at the time of hologram reproduction, derived are a phase conjugate reproduced image of a hologram A to be read by an incoming reference light, and a phase conjugate reproduced image of a hologram B to be read by the reflected reference light. With the production image of a phase conjugated wave, there is no influence by the objective lens over defocusing. When the reference light with 180-degree difference of the light incidence direction from the reference light used for recording enters the hologram, the result is a reproduced light with 180-degree difference in the direction from the signal light at the time of recording. Therefore, the reproduced light of a phase conjugated wave goes back the same path as the signal light at the time of recording. That is, there is no defocusing, no reflection on the reflection layer, and no passage again through the hologram recording layer. As such, the resulting reproduced image can be high in quality.

Moreover, as an alternative to the double focus objective lens OB3, as shown in FIG. 37, a through-light diffractive optical device DOE having a concave lens function at the center may be used as an objective lens module disposed immediately before the objective lens OB. If this is the case, the focus distance of the reference light beam RB may be different from that of the signal light beam SB. That is, by the objective lens OB and the objective lens module configured by the diffractive optical device DOE, in the state of being spatially separated from each other, the focus distance of the reference light beam RB at the center is set longer, and the focus distance of the signal light beam SB therearound is set shorter. At the time of recording and reproduction, the record carrier, the objective lens, and the diffractive optical device are disposed and configured in such a manner that, on the reflective layer disposed on the side opposite to the light incidence side of the hologram recording layer, the reference light beam RB forms a spot with no aberration (focus state) and is reflected, and the signal light beam SB is reflected on this reflective surface in the defocus state. The recording layer of the hologram record carrier is disposed between the focal point of the reference light beam RB and the focal point of the signal light beam SB, and therebetween, the hologram recording is performed with the interference between the incoming signal light beam SB and reference light beam RB.

With such a configuration, when the signal light beam SB is reflected, there is no overlap between the reference light beam RB and the reflected signal light beam SB.

In a case where the focal point of the signal light is located before the focal point of the reference light in this embodiment, in the configurations of FIGS. 10 to 21, the diffractive optical device DOE being a combination, coaxially, with the objective lens OB may be a Fresnel lens having the effects of a concave lens at the center of the optical axis or a diffractive optical device. Moreover, in the configurations of FIGS. 25 to 28, as an alternative to the convex lens optical device section C in the center are a including the optical axis in the spatial light modulator SLMa being a piece with a convex lens optical device, used may be a lens optical device section having the effects of a concave lens at the center of the optical axis or a diffractive optical device. Moreover, in the above-described configuration of FIG. 29, as an alternative to the concave mirror optical device section CM in the reflective polarization spatial light modulator PSLMa being a piece with a concave mirror optical device, used may be a convex mirror optical device or a diffractive optical device.

1. A hologram recording method of recording information to a hologram record carrier including a hologram recording layer stored therein with an optical interference pattern of a reference light and a signal light as a diffraction grating, the method comprising:
a step of disposing a reflective layer on a side opposite to a light exposure surface of the hologram recording layer; and
a step of directing, with convergence by an objective lens, a coherent reference light and a signal light being a result of modulating the reference light in accordance with recording information to the reflective layer, coaxially about an optical axis, to allow passage through the hologram recording layer, and making the lights reflected on the reflective layer, wherein
in the step of making the lights reflected on the reflective layer, the diffraction grating is formed through interference between the reference light and the signal light in the hologram recording layer by propagating the reference light on the optical axis for gathering on the reflective layer, and by propagating the signal light around the reference light with spatial separation from the reference light for irradiation in such a manner as to derive a defocus state on the reflective layer.

2. (canceled)

3. A hologram recording device, comprising:
a support section that keeps hold of, to be able to be attachable and removable, a hologram record carrier including a hologram recording layer stored therein with an optical interference pattern of a coherent signal light and a coherent reference light as a diffraction grating;
a light source that generates the coherent reference light;
a signal light generation section that is disposed on an optical axis, and generates the signal light by modulating the reference light in accordance with recording information; and
an interference section that is disposed on the optical axis, and forms the diffraction grating being the optical interference pattern inside of the hologram recording layer by directing the signal light and the reference light toward the hologram recording layer, wherein
the signal light generation section is provided with a spatial light modulator, and the spatial light modulator is disposed on the optical axis to generate, for propagation, the reference light on the optical axis and the signal light around the reference light with spatial separation therefrom, and
the interference section includes an objective lens and an optical device, and the objective lens and the optical device gather the reference light at a first focal point, and the signal light at a second focal point being further or closer to the objective lens than the first focal point.

4. The hologram recording device according to claim 3, wherein
the spatial light modulator is configured by a through-light center are a disposed on the optical axis for passing through the reference light with no modulation, and a spatial light modulation are a being a through-light matrix liquid crystal device disposed around the center are a for generating the signal light by modulating the reference light in accordance with the recording information.

5. The hologram recording device according to claim 4, wherein
the through-light center are a is a through aperture or made of a transparent material.

6. The hologram recording device according to claim 4, wherein
the through-light center are a is the through-light matrix liquid crystal device, and at the time of recording, the through-light center are a is ready for passage of light.

7. The hologram recording device according to claim 4, wherein
in the objective lens and the optical device, the optical device is a convex lens or a Fresnel lens with effects of the convex lens or a diffractive optical device formed on the through-light center are a of the spatial light modulator, or a concave lens or a Fresnel lens with effects of the concave lens or the diffractive optical device, and has a function of light gathering onto the first focal point by the objective lens.

8. The hologram recording device according to claim 3, wherein
the spatial light modulator is configured by a reflective center are a disposed on the optical axis for reflecting the reference light with no modulation, and a spatial light modulation are a being a reflective matrix spatial light modulator disposed around the center are a for generating the signal light by reflecting and modulating the reference light in accordance with the recording information.

9. The hologram recording device according to claim 8, wherein
the reflective center are a is the reflective matrix spatial light modulator, and at the time of recording, the reflective center are a is ready for regular reflection.

10. The hologram recording device according to claim 8, wherein
in the objective lens and the optical device, the optical device is a concave mirror or a diffractive optical device with effects of the concave mirror formed on the reflective center are a of the spatial modulator, or a convex mirror or a diffractive optical device with effects of the convex mirror, and has a function of light gathering onto the first focal point by the objective lens.

11. The hologram recording device according to claim 4, wherein
in the objective lens and the optical device, the optical device is a convex lens or a Fresnel lens with effects of the convex lens or a diffractive optical device disposed, coaxially, on a side of the light source of the objective lens, or a concave lens or a Fresnel lens with effects of the concave lens or the diffractive optical device, and has a function of light gathering onto the first focal point by the objective lens.

12. The hologram recording device according to claim 4, wherein
the objective lens and the optical device are a piece of a double focus lens including, coaxially on a refractive surface thereof, a Fresnel lens surface with effects of a convex lens or a diffraction grating, or a Fresnel lens surface with effects of a concave lens or the diffraction grating.

13. The hologram recording device according to claim 3, wherein
when a reflective layer is disposed on a side opposite to a light exposure surface of the hologram recording layer, and when the signal light and the reference light are directed from the hologram recording layer, the hologram recording layer is disposed between a conjugate point of the second focal point of the signal light and the first focal point of the reference light.

14. The hologram recording device according to claim 3, wherein
the hologram recording layer has a film thickness enough for the first focal point of the reference light to be formed on the reflective layer, for the signal light to be put in a defocus state and reflected on the reflective layer, and the entered or reflected signal light and reference light to intersect and interfere with each other for generating the diffraction grating.

15. The hologram recording device according to claim 3, wherein
the hologram record carrier is formed as a piece including the hologram recording layer and the reflective layer with a protection layer disposed therebetween.

16. The hologram recording device according to claim 3, wherein
the hologram record carrier configured by the hologram recording layer is formed separately from the reflective layer.

17. The hologram recording device according to claim 3, further including
a servo system for exercising servo control over tracking and focusing of the reference light using the reference light that is returned after reflection when the first focal point is formed to the reflective layer.

18. A hologram reproducing device, comprising:
a support section that, when a reflective layer is disposed on a side opposite to a light exposure surface of a hologram recording layer, and with convergence by an objective lens, when a coherent reference light and a signal light being a result of modulating the reference light in accordance with recording information are directed to the reflective layer, coaxially about an optical axis, to allow passage through the hologram recording layer, propagates the reference light on the optical axis for gathering on the reflective layer, and propagates the signal light around the reference light with spatial separation from the reference light for irradiation in such a manner as to derive a defocus state on the reflective layer, and at the time of light incidence to the reflective layer or after light reflection on the reflective layer, causes interference between the reference light and the signal light in the hologram recording layer for keeping hold of, to be able to be attachable/removable, a hologram record carrier stored therein with an optical interference pattern as a diffraction grating;
a light source that generates the reference light; and
an interference section that generates a reproduced wave corresponding to the signal light by directing the reference light to the diffraction grating, wherein
the support section keeps hold of the hologram record carrier in such a manner that the reflective layer comes on the side opposite to the light exposure surface of the hologram recording layer,
the interference section includes a photodetector disposed on the optical axis for detecting a reproduced light generated by the diffraction grating, and the objective lens for gathering the reference light on the optical axis in such a manner as to allow passage through the diffraction grating of the hologram recording layer, and receiving the reproduced wave for guiding to the photodetector, and
a servo system is included for exercising servo control over tracking and focusing of the reference light using the reference light that is returned from the reflective layer after reflection, and the photodetector for detecting the reproduced light is configured by a servo photodetection are a disposed on an optical axis of the servo system for receiving the reference light, and an image detection are a disposed around the servo photodetection are a for detecting the reproduced light.

19. The hologram reproducing device according to claim 18, wherein
the interference section includes an image-forming optical device for guiding the reproduced light to the photodetector between the objective lens and the photodetector, and the image-forming optical device is a convex lens, a Fresnel lens with effects of the convex lens or a diffractive optical device.

20. (canceled)

21. An optical pickup device that records or reproduces information to and from a hologram record carrier including a hologram recording layer stored therein with an optical interference pattern of a reference light and a signal light as a diffraction grating, comprising:
a light source that generates the coherent reference light; and
a spatial light modulator configured by a center are a disposed on an optical axis for passing through or reflecting the reference light, and a spatial light modulation are a disposed around the center are a for generating the signal light through partial separation of the reference light, and separates, for propagation, the reference light on the optical axis and the signal light around the reference light with spatial separation therefrom,
the interference section includes an objective lens and an optical device, and the objective lens and the optical device gather the reference light at a first focal point, and the signal light at a second focal point being farther or closer to the objective lens than the first focal point, and
the interference section includes photodetection means for, when the reference light is directed to the hologram recording layer, receiving and detecting a light returned from the hologram recording layer via the objective lens.

22. The optical pickup device according to claim 21, wherein
the spatial light modulator is a through-light matrix liquid crystal device, and in the objective lens and the optical device, the optical device is a Fresnel lens surface with effects of a convex lens or a diffraction grating formed on the center are a being a piece with the spatial modulator, or a concave lens or a Fresnel lens with effects of the concave lens or the diffractive optical device, and has a function of light gathering onto the first focal point by the objective lens.

23. The optical pickup device according to claim 21, wherein
the spatial light modulator is a reflective matrix polarization spatial light modulator, and in the objective lens and the optical device, the optical device is a concave mirror or a diffractive optical device with effects of the concave mirror formed on the center are a being a piece with the spatial modulator, or a convex mirror or a diffractive optical device with effects of the convex mirror, and has a function of light gathering onto the first focal point by the objective lens.

24. The optical pickup device according to claim 21, wherein
the objective lens and the optical device are a piece of a double focus lens including, coaxially on a refractive surface thereof, a Fresnel lens surface with effects of a convex lens or a diffraction grating, or a Fresnel lens surface with effects of a concave lens or the diffraction grating.

25. A hologram recording system that records information to a hologram record carrier including a hologram recording layer stored therein with an optical interference pattern of a reference light and a signal light as a diffraction grating, comprising:
generation means for generating a coherent reference light and a signal light being a result of modulating the reference light in accordance with recording information;
interference means provided with an objective lens optical system disposed on an optical axis for causing interference between the reference light and the signal light by propagating, coaxially, the reference light on the optical axis and the signal light circularly around the reference light with spatial separation therebetween, by gathering the reference light at a first focal point of the objective lens optical system, and by gathering the signal light at a second focal point being further or closer than the first focal point;
a hologram record carrier including the hologram recording layer between the first focal point and the second focal point; and
reflection means being positioned at the first focal point.

26. A hologram reproducing system that reproduces information from a hologram record carrier including a hologram recording layer stored therein with an optical interference pattern of a reference light and a signal light as a diffraction grating, comprising:
a hologram recording system that records information to a hologram record carrier including a hologram recording layer stored therein with an optical interference pattern of a reference light and a signal light as a diffraction grating, including:
generation means for generating a coherent reference light and a signal light being a result of modulating the reference light in accordance with recording information;
interference means provided with an objective lens optical system disposed on an optical axis for causing interference between the reference light and the signal light by propagating, coaxially, the reference light on the optical axis and the signal light circularly around the reference light with spatial separation therebetween, by gathering the reference light at a first focal point of the objective lens optical system, and by gathering the signal light at a second focal point being further or closer than the first focal point;
a hologram record carrier including the hologram recording layer between the first focal point and the second focal point; and
reflection means being positioned at the first focal point, and
detection means for, when generating a reproduced light from the diffraction grating by making the reference light pass through the diffraction grating of the hologram recording layer with convergence of the reference light at the first focal point by the objective lens optical system, guiding the reproduced light to a photodetector by the objective lens optical system.
